(19) United States
(12) Patent Application Publication
(10) Pub. No.: US 2026/0181602 A1
(43) Pub. Date: Jun. 25, 2026

(54) INACTIVITY TIMER DURING CELL DISCONTINUOUS TRANSMISSION/RECEPTION

(71) Applicant: Telefonaktiebolaget LM Ericsson (PUBL), Stockholm (SE)

(72) Inventors: Andres REIAL, Höllviken (SE); Sina MALEKI, Malmö (SE); Ali NADER, Malmö (SE); Pål FRENGER, Linköping (SE); Ajit NIMBALKER, Fremont, CA (US)

(21) Appl. No.: 19/126,781

(22) PCT Filed: Nov. 6, 2023
(86) PCT No.: PCT/EP2023/080798

§ 371 Date: May 2, 2025

Related U.S. Application Data
(60) Provisional application No. 63/382,317, filed on Nov. 4, 2022.

(51) Int. Cl. H04W 72/0446; H04L 5/00; H04W 72/23

(52) U.S. Cl. CPC H04W 72/0446; H04L 5/0048; H04L 5/0053; H04W 72/23

(57) ABSTRACT

According to some embodiments, a method is performed by a wireless device. The method comprises receiving, from a network node, a cell discontinuous transmission reception (DTRX) configuration comprising at least an onDuration parameter and an inactivity timer (IAT) duration period. The method further comprises receiving a downlink signal monitoring configuration and monitoring a downlink channel according to the downlink signal monitoring configuration. The method further comprises, while monitoring the downlink channel according to the downlink signal monitoring configuration and during an onDuration period, detecting an IAT triggering event. Based on the IAT triggering event being detected, the method further comprises extending a downlink monitoring window based on the IAT duration parameter and monitoring the downlink channel during the extended downlink monitoring window. An analogous method for signal transmission in a cell during DTRX is also presented.

### TECHNICAL FIELD

Embodiments of the present disclosure are directed to wireless communications and, more particularly, to an inactivity timer (IAT) during cell discontinuous transmission reception (DTRX).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Energy consumption is a considerable challenge of fifth generation (5G) systems today where a major contributor to the energy consumption is the radio unit of radio access network (RAN) system. The network (NW) power consumption for New Radio (NR) is said to be less compared to Long Term Evolution (LTE) because of its lean design, i.e., no cell specific reference signal (CRS) and the synchronization signal block (SSB) periodicity is by default 20 ms. However, NR in the current implementation might consume more energy compared to LTE, partly due to higher bandwidths (BWs), shorter transmission time intervals (TTIs) and massive number of antennas. This is still evident even at times when cells and beams are lightly loaded or serve no traffic or no users at all. One basic method for saving NW energy is to simply turn off a gNodeB (gNB) or a cell completely when it is seen or predicted that there is little or no traffic or even no user in the cell.

### Discontinuous Reception

NR, similar to LTE, includes mechanisms for discontinuous reception (DRX) for the UEs to reduce user equipment (UE) power consumption. DRX may be used both in Radio Resource Control (RRC) connected mode (C-DRX or cDRX) and RRC Idle/Inactive (DRX) and serves as a common agreement between the UE and the NW that upon any downlink (DL) traffic, the NW will only try to contact the UE during the on-time of the DRX pattern. Based on a configured DRX cycle, the UE then only needs to monitor the DL channels according to the agreement and sleep otherwise. When it comes to uplink (UL) traffic, the UE may initiate connection regardless of the DRX configuration, i.e., the gNB has to be prepared to receive UL at any time.

### UE Timers and Triggers in cDRX

Multiple timers are defined in TR 38.331 to control the UE behavior in legacy operation. The timers are generally defined by actions to be performed by the UE upon start, stop and at expiry of the timer as depicted also in the table below. In particular, the drx-Inactivity Timer in cDRX extends the physical downlink control channel (PDCCH) monitoring duration by the UE after a received PDCCH that indicates new data, so that the monitoring continues beyond the nominal cDRX onDuration, as shown in FIG. 1.

### Cell DTRX

To improve network energy efficiency, a concept similar to the UE cDRX may be considered where a gNB may configure time intervals during which no receiver (RX) and/or transmitter (TX) transmissions are performed and the gNB has the opportunity to turn off its receiver and/or transmitter blocks or processing units, or apply reduced-power states. The UEs may be configured with such a DTRX schedule and refrain from transmitting or attempting to receive signals to/from the gNB during the corresponding offDurations.

NW, or cell DTRX or cell DTX/DRX is proposed within Rel 18 NW energy saving system information (SI) as a solution to help the NW to save more power. The idea is that the NW in known time/frequency resources is active or inactive resembling the C-DRX or DRX mechanisms at the UE side, and thereby can go to appropriate sleep mode during inactive time. Furthermore, when possible, the UE and gNB are aligned during this operation.

### SUMMARY

There currently exist certain challenges. For example, in the UE cDRX framework (not addressed herein), the nominal onDuration schedule is followed only if no data-related PDCCH transmissions to the UE occur during the nominal onDuration. If the UE receives a PDCCH, the drx-Inactivity Timer extends the monitoring window to facilitate handling follow-up transmissions in the ongoing data burst or DL/UL transmission sequence or procedure.

In the currently discussed cell DTRX framework, the on/offDuration schedule has been proposed but no policies for extending permissible UL or DL activity windows have been considered. The applicant has appreciated that without such policies, following the nominal on/offDurations may lead to inability to maintain responsive traffic patterns or meet relevant quality of service (QoS)/quality of experience (QoE) requirements for individual UEs.

The UE cDRX inactivity timer (IAT) approach, applied on a per-UE basis, is not however directly applicable to the NW DTRX context because the DTRX assumptions need to be compatible for all UEs in a cell and activity of one UE may preferably affect activity/inactivity patterns of other UEs.

There is thus a need for a network DTRX IAT mechanism that enables energy savings in the gNB but does not unduly interfere with data transmissions to and from individual user equipment (UE).

Certain aspects of the disclosure and their embodiments may provide solutions to these or other challenges. For example, methods and systems are provided for a cell DTRX framework that includes an IAT mechanism where activity during the onDuration extends the active time by the timer duration to accommodate possible additional transmissions associated with an ongoing data burst or application transaction for some UE.

According to particular embodiments, the IAT may be triggered by a legacy physical downlink control channel (PDCCH)/downlink control information (DCI) transmission, an uplink transmission or uplink grant, or an explicit IAT trigger signal during the nominal onDuration, e.g. via a field in a DCI.

At least the currently active UE, and optionally additional UEs, may use the extended active time window.

According to some embodiments, a method for signal reception in a cell using cell DTRX is performed by a wireless device. The method comprises receiving, from a network node, a cell DTRX configuration that comprises at least onDuration parameter and an IAT duration parameter. The method further comprises receiving a downlink signal monitoring configuration. The method further comprises monitoring a downlink channel according to the downlink signal monitoring configuration. The method further comprises detecting an IAT triggering event, while monitoring the downlink channel according to the downlink signal monitoring configuration and during an onDuration period. The method further comprises extending a downlink monitoring window based on the IAT duration parameter based on the IAT triggering event being detected. The method further comprises monitoring the downlink channel during the extended downlink monitoring window.

In particular embodiments, the method may further comprise terminating monitoring of the downlink channel at an end of the extended downlink monitoring window. In particular embodiments, the method may further comprise receiving, from the network node, an indication that no further downlink communication is expected and, based on the indication, terminating the monitoring of the downlink channel prior to an end of the extended monitoring window. In particular embodiments, the method may further comprise receiving a configuration indicating a field within at least one DCI format. In particular embodiments, the IAT triggering event may be detected based on a value in the field in a received DCI.

In particular embodiments, the onDuration parameter is the downlink monitoring window.

In particular embodiments, the cell DTRX configuration further comprises a cell DTX onDuration.

In particular embodiments, the IAT duration parameter comprises an amount of time for extending the downlink monitoring window. In particular embodiments, the amount of time for extending the downlink monitoring window initiates at a time instant associated with the detection of the IAT triggering event.

In particular embodiments, the downlink signal monitoring configuration comprises at least one of connected mode DRX (cDRX) or search space.

In particular embodiments, the cell DTRX configuration further comprises information indicating whether the IAT should be triggered or information indicating at least one activity in the downlink channel associated with the IAT triggering event.

In particular embodiments, the IAT triggering event comprises at least one of: a PDCCH and/or DCI transmission to the first UE in the cell; a PDCCH or DCI transmission to a second UE in the cell; a PDCCH or DCI transmission comprising scheduling new data; non-scheduling DCI; a downlink reference signal; a dedicated transmission indicating an IAT triggering event that triggers a preconfigured IAT duration; a broadcast transmission indicating an IAT triggering event that triggers a preconfigured IAT duration; a dedicated transmission indicating an IAT duration value; and a broadcast transmission indicating an IAT duration value.

According to some embodiments, a method for signal transmission in a cell using cell DTRX comprises receiving, from a network node, a cell DTRX configuration comprising at least an onDuration parameter and an IAT duration parameter. The method further comprises receiving an uplink signal transmission configuration. The method further comprises transmitting, during an onDuration period, an uplink transmission according to the uplink signal transmission configuration. The method further comprises detecting an IAT triggering event. The method further comprises extending an uplink transmission window based on the IAT duration parameter based on the IAT triggering event being detected. The method further comprises transmitting a further uplink transmission during the extended uplink transmission window.

In particular embodiments, the method may further comprise terminating the transmission of the uplink transmission at an end of the extended uplink monitoring window. In particular embodiments, the method may further comprise transmitting, to the network node, an indication that no further uplink communication is expected; and based on the indication, terminating the transmission of the uplink transmission prior to an end of the extended uplink transmission window. In particular embodiments, the method may further comprise transmitting, to the network node, an indication that the UE prefers to trigger the IAT. In particular embodiments, the method may further comprise receiving a configuration indicating a field within at least one DCI format. In particular embodiments, the IAT triggering event may be detected based on a value in the field in a received DCI.

In particular embodiments, the onDuration parameter is the uplink monitoring window.

In particular embodiments, the cell DTRX configuration further comprises a cell DRX onDuration,

In particular embodiments, the IAT duration parameter comprises an amount of time for extending the uplink monitoring window. In particular embodiments, the amount of time for extending the uplink monitoring window initiates at a time instant associated with the detection of the IAT triggering event.

In particular embodiments, the uplink signal transmission configuration comprises at least one of an uplink grant and at least one transmission resource.

In particular embodiments, the cell DTRX configuration further comprises information indicating whether the IAT should be triggered or information indicating at least one activity associated with the IAT triggering event.

In particular embodiments, the IAT triggering event comprises at least one of: an uplink transmission by the first UE; an uplink grant to the first UE; downlink scheduling to the first UE; a PDCCH or DCI transmission to the first UE in the cell; a physical uplink control channel (PUCCH) or uplink control information (UCI), transmission by a second UE in the cell; a dedicated transmission indicating the IAT triggering event; and a broadcast transmission indicating the IAT triggering event.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method for configuring a user equipment (e.g., a wireless device) for signal transmission or reception in a cell using cell DTRX is performed by a network node. The method comprises transmitting, to a first UE a cell DTRX configuration comprising at least an onDuration parameter and an IAT duration parameter. The method further comprises transmitting, to the first UE, a downlink signal monitoring configuration. The method further comprises configuring the first UE to, while monitoring a downlink channel according to the downlink signal monitoring configuration and during an onDuration period, detect an IAT triggering event. The method further comprises configuring the first UE to, based on the IAT triggering event being detected, extend a downlink monitoring window based on the IAT duration parameter. The method further comprises transmitting on the downlink channel during the extended downlink monitoring window.

In particular embodiments, the method may further comprise configuring the first UE to terminate the monitoring of the downlink channel at an end of the extended monitoring window. In particular embodiments, the method may further comprise transmitting to the first UE an indication that no further downlink communication is expected; and based on the indication, the monitoring of the downlink channel is terminated prior to an end of the extended monitoring window. In particular embodiments, the method may further comprise transmitting, to the first UE, a configuration indicating a field within at least one DCI format. In particular embodiments, the IAT triggering event may be detected based on a value in the field in a received DCI.

In particular embodiments, the onDuration parameter is the downlink monitoring window.

In particular embodiments, the cell DTRX configuration further comprises a cell DTX onDuration.

In particular embodiments, the IAT duration parameter comprises an amount of time for extending the downlink monitoring window. In particular embodiments, the amount of time for extending the downlink monitoring window initiates at a time instant associated with the detection of the IAT triggering event.

In particular embodiments, the downlink signal monitoring configuration comprises at least one of connected mode DRX or search space.

In particular embodiments, the cell DTRX configuration further comprises information indicating whether the IAT should be triggered or information indicating at least one activity in the downlink channel associated with the IAT triggering event.

In particular embodiments, the IAT triggering event comprises at least one of: a PDCCH or DCI transmission to the first UE in the cell; a PDCCH or DCI transmission to a second UE in the cell; a PDCCH or DCI transmission comprising scheduling new data; non-scheduling DCI; a downlink reference signal; a dedicated transmission indicating an IAT triggering event that triggers a preconfigured IAT duration; a broadcast transmission indicating an IAT triggering event that triggers a preconfigured IAT duration; a dedicated transmission indicating an IAT duration value; and a broadcast transmission indicating an IAT duration value.

In particular embodiments, the network node comprises a gNodeB (gNB).

According to some embodiments, a method for configuring a user equipment for signal transmission or reception in a cell using cell DTRX is performed by a network node. The method comprises transmitting, to a first UE a cell DTRX configuration comprising at least an onDuration parameter and an IAT duration parameter. The method further comprises transmitting, to the first UE, an uplink signal transmission configuration. The method further comprises configuring the first UE to transmit the uplink transmission based on the uplink signal transmission configuration and during an onDuration period. The method further comprises configuring the first UE to, based on the IAT triggering event being detected, extend an uplink transmission window based on the IAT duration parameter. The method further comprises receiving, from the UE, the uplink transmission during the extended uplink transmission window.

In particular embodiments, the method may further comprise configuring the first UE to terminate the transmission of the uplink transmission at an end of the extended uplink transmission window. In particular embodiments, the method may further comprise receiving, from the first UE, an indication that no further uplink communication is expected, and based on the indication, the transmission of the uplink transmission is terminated prior to an end of the extended uplink transmission window. In particular embodiments, the method may further comprise receiving, from the first UE, an indication that the first UE prefers to trigger the IAT. In particular embodiments, the method may further comprise transmitting to the first UE, a configuration indicating a field within at least one DCI format, and the IAT triggering event is detected based on a value in the field in a transmitted DCI.

In particular embodiments, the onDuration parameter is the uplink monitoring window.

In particular embodiments, the cell DTRX configuration further comprises a cell DRX onDuration.

In particular embodiments, the IAT duration parameter comprises an amount of time for extending the uplink monitoring window. In particular embodiments, the amount of time for extending the uplink monitoring window initiates at a time instant associated with the detection of the IAT triggering event.

In particular embodiments, the uplink signal transmission configuration comprises at least one of an uplink grant and/or at least one transmission resource.

In particular embodiments, the cell DTRX configuration further comprises information indicating whether the IAT should be triggered or information indicating at least one activity associated with the IAT triggering event.

In particular embodiments, the IAT triggering event comprises at least one of: an uplink transmission by the first UE; an uplink grant to the first UE; downlink scheduling to the first UE; a PUCCH or UCI transmission by the first UE in the cell; a PUCCH or UCI transmission by a second UE in the cell; a dedicated transmission indicating the IAT triggering event; and a broadcast transmission indicating the IAT triggering event.

In particular embodiments, the network node comprises a gNodeB (gNB).

According to some embodiments, a network node comprises processing circuitry operable to perform any of the methods of the network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, certain embodiments may provide a technical advantage of providing an IAT mechanism that facilitates the cell DTRX active time to be extended when needed to minimize the risk of blocking pending follow-up transmissions. Thus, average gNB energy savings may be maintained or increased without degrading quality of service (QoS)/quality of experience (QoE). As another example, certain embodiments may provide a technical advantage of enabling separate downlink and uplink patterns to facilitate a larger flexibility in configuration and maximize the energy savings. Some embodiments may control the uplink and downlink patterns together.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a timing diagram illustrating user equipment (UE) timers and triggers in discontinuous reception (DRX);

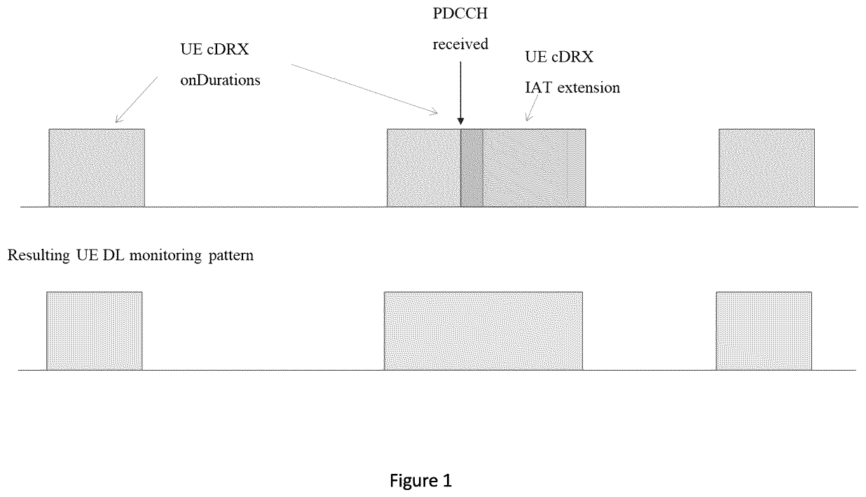

FIG. 2 is a flowchart illustrating an example method including steps for cell discontinuous transmission (DTX) operation with inactivity timer (IAT) in a first UE, according to certain embodiments;

FIG. 3 is a timing diagram illustrating an example procedure and shows the result of applying the cell DTX and IAT on the resulting UE downlink monitoring pattern in cDRX, according to certain embodiments;

FIG. 4 is a flowchart illustrating another example method for cell DRX operation with IAT in a first UE, according to certain embodiments;

FIG. 5 is a timing diagram illustrating an example procedure that exemplifies the scheduling request (SR) transmission scenario, according to certain embodiments;

FIG. 6 is a flowchart illustrating an example method for cell DRX operation with IAT in a first UE when it is performing cell DTRX for both downlink and uplink using a single DTRX setting, onDuration and IAT, according to certain embodiments:

FIG. 7 illustrates an example communication system, according to certain embodiments;

FIG. 8 illustrates an example UE, according to certain embodiments;

FIG. 9 illustrates an example network node, according to certain embodiments;

FIG. 10 illustrates a block diagram of a host, according to certain embodiments;

FIG. 11 illustrates a virtualization environment in which functions implemented by some embodiments may be virtualized, according to certain embodiments;

FIG. 12 illustrates a host communicating via a network node with a UE over a partially wireless connection, according to certain embodiments;

FIG. 13A illustrates a method performed by a wireless device, according to certain embodiments;

FIG. 13B illustrates another method performed by a wireless device, according to certain embodiments;

FIG. 14A illustrates a method performed by a network node, according to certain

FIG. 14B illustrates another method performed by a network node, according to certain embodiments.

### DETAILED DESCRIPTION

As described above, certain challenges currently exist with inactivity timer (IAT) during cell discontinuous transmission reception (DTRX). There is thus a need for a network DTRX IAT mechanism that enables energy savings in the gNB but does not unduly interfere with data transmissions to and from individual user equipment (UE).

Certain aspects of the disclosure and their embodiments may provide solutions to these or other challenges. For example, methods and systems are provided for a cell DTRX framework that includes an IAT mechanism where activity during the onDuration extends the active time by the timer duration to accommodate possible additional transmissions associated with an ongoing data burst or application transaction for some UE.

Some of the embodiments contemplated herein will now be described more fully with reference to the accompanying drawings. Embodiments are provided by way of example to convey the scope of the subject matter to those skilled in the art.

As used herein, ‘node’ can be a network node or a user equipment (UE). Examples of network nodes are NodeB, base station (BS), multi-standard radio (MSR) radio node such as MSR BS, eNodeB (eNB), gNodeB (gNB), master eNB (MeNB), secondary eNB (SeNB), integrated access backhaul (IAB) node, network controller, radio network controller (RNC), base station controller (BSC), relay, donor node controlling relay, base transceiver station (BTS), central unit (e.g. in a gNB), distributed unit (e.g. in a gNB), baseband unit, centralized baseband, C-RAN, access point (AP), transmission points, transmission nodes, remote radio unit (RRU), remote radio head (RRH), nodes in distributed antenna system (DAS), core network node (e.g. mobile switching center (MSC), mobility management entity (MME), etc.), operations and maintenance (O&M), operations support system (OSS), self-organizing network (SON), positioning node (e.g. E-SMLC), etc.

Another example of a node is a UE, which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, personal digital assistant (PDA), tablet, mobile terminals, smart phone, laptop embedded equipment (LEE), laptop mounted equipment (LME), unified serial bus (USB) dongles, etc.

In some embodiments, generic terminology, “radio network node” or simply “network node (NW node)”, is used. It can be any kind of network node which may comprise base station, radio base station, base transceiver station, base station controller, network controller, eNB, Node B, gNB, relay node, access point, radio access point, RRU, RRH, central unit (e.g., in a gNB), distributed unit (e.g., in a gNB), baseband unit, centralized baseband, C-RAN, AP, etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, New Radio (NR), fourth generation (4G), fifth generation (5G), etc. Any of the equipment denoted by the terms node, network node or radio network node may be capable of supporting a single or multiple RATs.

In the following discussion, various terms may be used to refer to cell DTX/DRX; it may also be referred to cell DTRX, gNB DTRX or DTX/DRX, or NW DTRX or DTX/DRX. All such terms are used interchangeably.

Particular embodiments, for the cell DTRX concept, include an inactivity timer aspect. If there is an ongoing data burst or activity sequence for a UE, the gNB will not go to sleep just because the formal off-duration starts. The gNB remains active until the end of the burst, and in some scenarios the gNB also remains active for a time after to wait for possible follow-up transmissions from/towards the UE.

In some embodiments, other UEs may still consider the gNB as “off” according to the configured/indicated DTRX pattern. But if the gNB is not actually off, there may be benefits for UEs that need to access the network because the UEs do not need to wait as long as the next gNB DTRX onDuration. An IAT principle is applied such that the gNB is still available for some time after the latest activity, extending beyond the end of the nominal onDuration.

The cell DTRX may limit both the “possible but not predetermined downlink activity” windows (e.g. scheduling or paging physical downlink control channel (PDCCH)) where UEs should monitor according to their paging occasion (PO) or search space (SS) only during the onDuration, and the “possible but not predetermined uplink activity” windows (e.g. scheduling request (SR), configured grants, physical random access channel (PRACH) preamble, etc.) where UEs may choose to transmit in the uplink (UL) according to their previously provided configurations, again only during the onDuration. The IAT then extends those windows to accommodate burst or access procedure continuation, etc.

The current cell DTRX concept has a different perspective from the cell-level versus the UE-level. Except for some exceptions described later, the DTRX is straightforwardly seen from a UE perspective: during configured onDurations, legacy operation is valid, and during offDurations, downlink (DL) and/or uplink activities are suspended/cancelled. In one example, from the gNB perspective, the cell is only in DTRX if the last UE leaves a potential IAT.

According to certain embodiments, for example, a method in a first UE for signal reception in the downlink operating in a cell using DTRX includes:
. receiving a cell DTRX configuration that comprises at least an onDuration parameter and an IAT parameter,
receiving a DL signal monitoring configuration [cDRX, search space, etc.],
monitoring the DL according to the DL signal monitoring configuration during the onDuration,
if an IAT trigger event is not observed, terminating the DL monitoring at the end of the onDuration,
if an IAT trigger event is observed, extending the DL monitoring window by the IAT duration parameter from the trigger event time instant, and
continuing to monitor the DL according to the DL signal monitoring configuration, and terminating the DL monitoring at the end of the extended monitoring window.

In a particular embodiment, the cell DTRX configuration parameters comprise a cell DTX parameter. [Separate DL and UL configurations provided.]

In a particular embodiment, the cell DTRX configuration parameters may comprise information whether IAT shall or shall not be triggered, and/or by which activities in DL it shall be triggered.

In a particular embodiment, the IAT trigger event is a legacy PDCCH/DCI transmission to the first UE. [I.e., Only UEs targeted during the regular onDuration can continue monitoring during the IAT.]

In a particular embodiment, the IAT trigger event is a legacy PDCCH/DCI transmission to a second UE in the cell. [i.e., also UEs not targeted during the regular onDuration can continue monitoring during the IAT.]

In a particular embodiment, the IAT trigger event is a PDCCH/DCI transmission including scheduling new data.

In a particular embodiment, the IAT trigger event is a non-scheduling DCI, [e.g., a wakeup signal (WUS) DCI indicating the UE should monitor PDCCH during the next C-DRX onDuration time, or a paging DCI, or a paging early indicator DCI.]

In a particular embodiment, the IAT trigger event may be a DL reference signal, [e.g., a sequence or a reference signal such as an SSB, TRS].

In a particular embodiment, the IAT trigger event is a dedicated or group transmission [DCI or medium access control (MAC) control element (CE)] indicating an IAT trigger [explicit DL activity window extension signal which may either be specific for IAT extension (e.g., a specific PDCCH or other signal) or be embedded in other transmission (e.g., an indicator in a scheduling PDCCH)], that triggers a preconfigured IAT duration or comprise an IAT duration value.

In a particular embodiment, the UE receives indication in the DL that the gNB is not expecting further communication for the remainder of the IAT [an early termination of the IAT].

In a particular embodiment, the method includes the UE receiving a configuration indicating the presence of at least an explicit field within one or more DCI formats ([0_1/1_1/0_2/1_2/2_X.]), and assessing at least one of whether an IAT trigger event has occurred or not occurred based on the value of the explicit field determined from a detected downlink control information, and adapting an IAT value based on the assessment.

According to certain embodiments, a method in a UE for signal transmission in the UL operating in a cell using DTRX includes:
receiving a cell DTRX configuration that comprises at least an onDuration parameter and an IAT parameter,
receiving an UL signal transmission configuration [UL grant, PRACH resources, etc.],
performing UL transmission according to the UL signal transmission configuration during the onDuration,
if an IAT trigger event is not observed, not performing UL transmission after the end of the onDuration,
if an IAT trigger event is observed, extending the UL transmission window by the IAT duration parameter from the trigger event time instant and
performing UL transmission between the trigger instant and the end of the extended transmission window as needed.

In a particular embodiment, the cell DTRX configuration parameters comprise a cell DRX parameter. [Separate DL and UL configurations provided.]

In a particular embodiment, the cell DTRX configuration parameters may comprise information whether IAT may or may not be triggered, and/or by which activities in UL it may be triggered.

In a particular embodiment, the UE may indicate in the UL whether it prefers to trigger the IAT.

In a particular embodiment, the IAT trigger event is a legacy UL transmission by the first UE or a legacy UL grant to the first UE. [i.e., only UEs with active UL or granted/targeted during the regular onDuration can continue transmitting during the IAT.]

In a particular embodiment, the IAT trigger event is a legacy any DL scheduling to the first UE, in case an UL response is needed shortly. [i.e., also UEs not active in UL or granted/targeted during the regular onDuration can continue transmitting during the IAT.]

In a particular embodiment, the IAT trigger event is a legacy physical uplink control channel (PUCCH)/uplink control information (UCI) transmission by a second UE in the cell.

In a particular embodiment, the IAT trigger event is a dedicated or group transmission [DCI or MAC CE] indicating an IAT trigger [explicit UL activity window extension signal].

In a particular embodiment, the UE may indicate in the UL whether it is not expecting further communication for the remainder of the IAT, and in response receiving from the NW an indication of early termination of the IAT.

In a particular embodiment, the UE receives a configuration indicating the presence of at least an explicit field within one or more DCI formats ([0_1/1_1/0_2/1_2/2_X.]), and assessing at least one of whether an IAT trigger event has occurred or not occurred based on the value of the explicit field determined from a detected downlink control information, and adapting an IAT value based on the assessment.

### Handling UEs With and Without Recent DL And/or UL Activity

One challenge for defining cell-wide gNB DTRX IAT is how a currently non-communicating UE becomes aware of transmissions to/from other UE in the cell that might trigger the IAT.

### IAT Applies Only to Currently Active UE(s)

In a particular embodiment, the IAT may apply only to UE(s) that have explicitly received DL transmissions during the ongoing onDuration and may thus unambiguously trigger the IAT and continue ongoing procedures.

For example, a UE may use additional DL or UL occasions if it has detected an IAT-triggering transmission. (If the UE does not detect some DL activity, the only loss would be in not using the opportunity.)

For other UE's, not detecting the first UE's activity, there will be some additional scheduling delay, similar to that experienced during UE CDRX Off time). In a particular embodiment, for example, an “on time” may be configured using a bitmap (one bit per slot/symbol with a periodicity, where if the bit is set, the slot is in “On time”, and if the bit is not set, the slot may in Off). A UE may monitor the “on time” even with IAT is running/not running. For example, SSB slot can be indicated as “On time” (e.g. 2 ms every 20 ms also) while the IAT cannot be assumed to be triggered, (For TDD, the TDD pattern may have separate UL and DL On times). The UE may monitor DL during these on-times. CDRX may be configured and overlaid on top (e.g. so that UEs don't need to be wake-up every 20 ms).

Another option is to create a common indication (like DCI 2_6 or more preferable the DCI 1_0 with SI-RNTI, which is almost periodic and has enough ‘reserved’ fields to carry the explicit indication of DTRX) that all UEs are configured to monitor, but then the gNB may configure which option it would like to use. Thus, inactivity does not apply to the SSB slots. For example, even if inactivity is indicated for 40 ms, gNB is up for two SSB slots in those 40 ms and UE could also be up in those slots (monitoring PDCCH, etc.) and NW can schedule the UE to reset inactivity. Even with UE-specific cell IAT triggering, the gNB can manage CDRX-cell DTRX interactions via scheduling. The currently not scheduled UE has its own schedule/configuration to wake up and monitor for gNB information.

Thus, a UE that has not communicated with gNB may only assume that gNB transmissions/receptions are limited to a small set of periodic/configured/indicated slots (e.g. SSB slot + an UL slot every 20 ms). If UE needs service, it sends an uplink signal, and waits for gNB to respond after a certain delay. If gNB needs to schedule the UE, the gNB waits until the next “On time” for the UE and schedules the UE. The gNB may be obligated to send some extra RSs because the gNB has extended IAT for one UE, but it may not be necessary for the gNB to communicate to other UEs that these extra RSs are present. Optionally, the gNB can use 1_0 with SI-RNTI to advertise these resources to other interested UEs.

### IAT Applies to All UEs in the Cell Via Explicit Signaling of IAT by the gNB

According to certain embodiments, there may be a flag in SSB (if transmitted) or another signal/channel, e.g. DCI, indicating if gNB continues active in DL or UL due to IAT triggered by activity of some UEs. It can also be that UL signal can end DTX off or other conditions. The DCI can be a broadcast DCI such as DCI 1_0/0_0 with CRC scrambled by a SI-RNTI, P-RNTI, or a special cell-specific RNTI dedicated for cell DTRX indication.

In a particular embodiment, a DCI is transmitted that may trigger a previously configured (e.g. via RRC) IAT duration. The UE may previously receive a configuration of one or multiple IAT values and determine the IAT value to apply based on an indication via an explicit field within a detected DCI. O

In another particular embodiment, the DCI triggering the IAT contains an explicit IAT duration value.

In a particular embodiment, the NW transmits a common RNTI PDCCH IAT trigger DCI also in parallel with the second UE's scheduling DCI, which would be a small PDCCH on top of second UE's PDCCH.

### IAT Applies to All UEs Assuming That Non-Active UEs Detect IAT-Triggering Activity to/From Other UEs

According to certain embodiments, a UE that has not communicated to the gNB can become aware that gNB is still active. There may be separate IATs for DL and UL, separately and optionally configured, where the UL and DL logic may be separated. A currently active UE can apply IATs in both directions because it is aware of its activity on both sides.

In the DL, other UEs may see if the gNB transmits anything that is not part of periodic signal patterns (e.g. PDxCH, not SSB, CSI-RS etc.) during the on-durations.

For example, in a particular embodiment, the first UE may be able to reliably detect PDCCH/DCI to another UE although it cannot perform CRC check due to unknown RNTI):
Based on that a decoder metric above threshold for any PDCCH format/resource in the SSs
Detecting signal energy consistent with PDCCH transmissions

If the detection is incorrect, e.g. if the NW starts the IAT but a UE does not realize it, a DL transmission attempt to that fails, the gNB can retry during the next nominal onDuration On the other hand, If the NW does not start the IAT but some UE thinks it has, the UE performs DL monitoring and simply forfeits some energy savings but no functional problems

In the UL, it may be harder for a UE to detect UL activity from other UEs. A UE may however be able to detect UL grants being provided in the DL using the DCI decoding described

If such detection is not robust, e.g. if the network starts the IAT but UEs do not realize it, the gNB continues UL monitoring for e.g. PRACH or PUSCH according to a configured grant and forfeits some energy savings but no functional problems. Also, the gNB may expect a PUSCH according to a one-time UL grant that will not arrive, in which case the gNB may provide a new grant during next nominal onDuration In one embodiment, the gNB does not provide a grant to a UE that falls outside the active time extension directly observable by that UE. On the other hand, if the network does not start the IAT but some UE thinks it has, UL transmission attempt fails, in which case the UE can retry during the next nominal onDuration.

### Additional Details of DL Operation (Cell DTX)

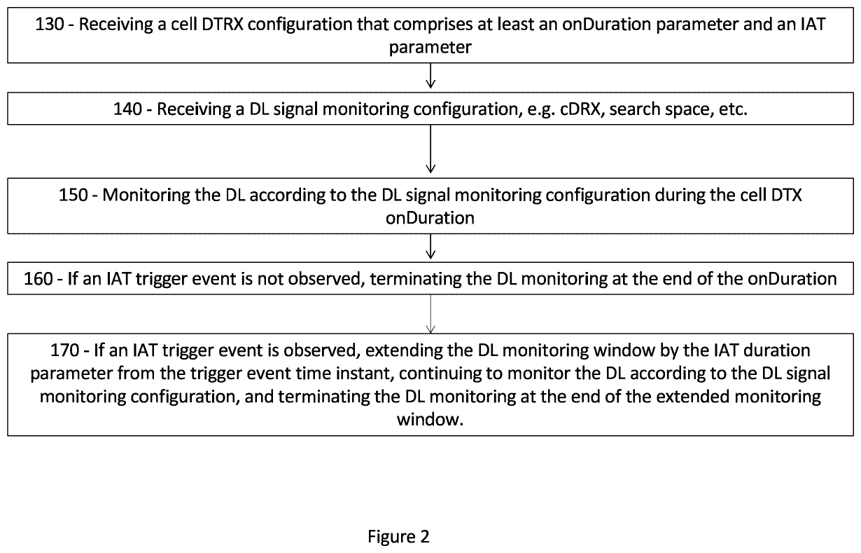

FIG. 2 illustrates an example method including steps for cell DTX operation with IAT in a first UE, according to certain embodiments.

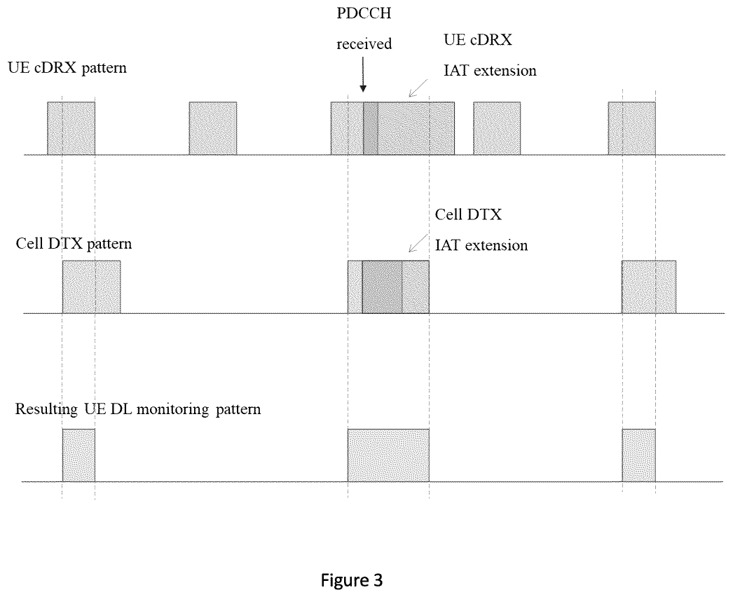

FIG. 3 illustrates an example procedure and shows the result of applying the cell DTX and IAT on the resulting UE downlink monitoring pattern in cDRX, according to certain embodiments. The on-and offDuration lengths depicted in FIG. 2 are not to scale, and search space pattern details during UE cDRX onDurations are omitted.

In a particular embodiment, separate DL and UL configurations provided separately and the cell DTX parameter is independent of the cell DRX parameter.

The cell DTRX configuration parameters may comprise information whether IAT shall or shall not be triggered, and/or by which activities in DL it shall be triggered. For example, it may be not triggered by PDCCH related to system information update, but triggered by PDCCH related to unicast data.

Multiple types of IAT trigger events may be considered, for example:
a legacy PDCCH/DCI transmission to the first UE, in which case only UEs targeted during the regular onDuration can continue monitoring during the IAT.
a legacy PDCCH/DCI transmission to a second UE in the cell, in which case also UEs not targeted during the regular onDuration can continue monitoring during the IAT.
a PDCCH/DCI transmission including scheduling new data, e.g., the UE receives a scheduling DCI indicating that a new data is being scheduled for the UE. Alternatively, the scheduling DCI may not indicate new data, e.g., a CSI-RS request or a DCI related to HARQ retransmission, in this case in one example the IAT is not triggered but the UE needs to perform the requested task, e.g., transmit a CSI report, or finish the currently running task.
a non-scheduling DCI, e.g., a WUS DCI indicating the UE should monitor PDCCH during the next C-DRX onDuration timer, or a paging DCI, or a paging early indicator DCI.
another type of DL signal, e.g., a sequence or a reference signal.
a dedicated or group transmission, e.g. a DCI or MAC CE indicating an IAT trigger. This is an explicit DL activity window extension signal which may either be specific for IAT extension (e.g., a specific PDCCH or other signal) or be embedded in other transmission (e.g., an indicator in a scheduling PDCCH). In one example, the UE is further configured to transmit an ACK or a group ACK to the NW indicating that it has received the indication regarding the IAT being triggered. The DCI may trigger a preconfigured IAT duration or comprise an IAT duration value. The UE receives a configuration of one or multiple IAT values and determines an IAT value to apply based on an indication via an explicit field within a detected DCI. In one embodiment, the UE receives a configuration indicating the presence of at least one explicit field within one or more DCI formats ([0_1/1_1/0_2/1_2/ 2_X.]), and assessing at least one of whether an IAT trigger event has occurred or not occurred based on the value of the explicit field determined from a detected downlink control information, and adapting an IAT value based on the assessment.

In a particular embodiment, the UE receives indication in the DL that the gNB is not expecting further communication for the remainder of the IAT. This amounts to an early termination of the IAT. The indication can be UE specific or group common, or be based on a DCI or another DL signal, e.g., a sequence or a reference signal. E.g., presence of a specific RS may indicate that the NW is active and its absence indicates that the NW is not active.

According to already established UE DRX rules, the gNB should not transmit in DL to a connected UE when it is not listening. There are rules defining how the UE onDuration is extended when it receives something in the DL. The key difference with the gNB DTX is that individual UEs have personal cDRX configurations but the gNB DTX may be considered common for all UEs in the cell. For some UEs they may not overlap (although that would be optimal) and additional rules effectively apply to the “intersection” of UE and gNB onDurations. There is also an complement where different UEs' CDRX configurations are switched to/from a common DRX configuration based on gNB need.

### Additional Details of UL Operation (Cell DRX)

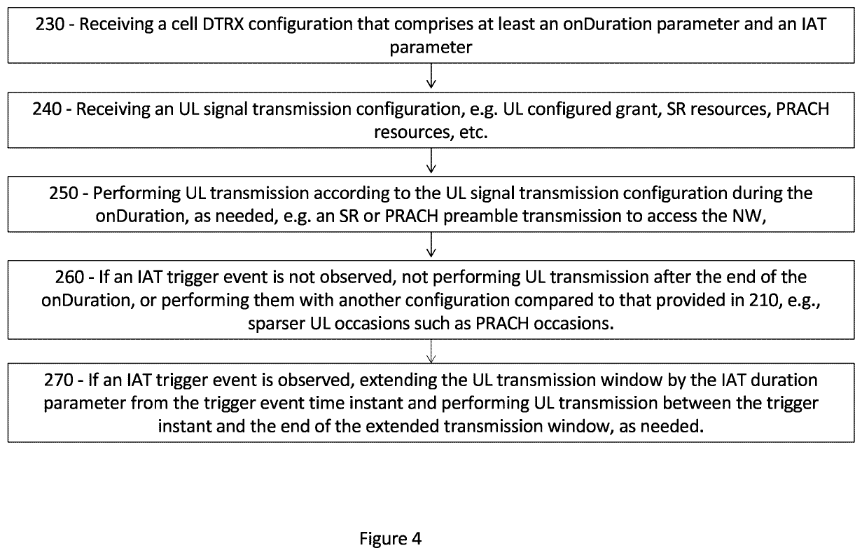

FIG. 4 illustrates another example method for cell DRX operation with IAT in a first UE, according to certain embodiments.

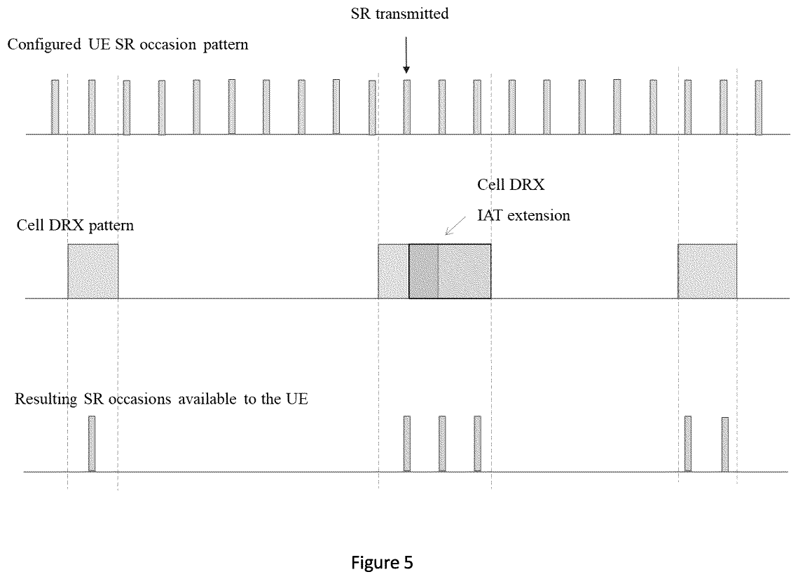

FIG. 5 illustrates an example procedure that exemplifies the SR transmission scenario, according to certain embodiments.

In a particular embodiment, the NW DTRX configuration parameters may comprise information whether IAT may or may not be triggered, and/or by which activities in UL it may be triggered (e.g., not triggered by UL transmission related to CSI report, but may be triggered by PUCCH related to scheduling request).

In a particular embodiment, the UE may indicate in the UL whether it is interested in triggering IAT (e.g., via explicit PRACH or PUCCH resources or including an indicator in the UL message such as a MAC-CE or alike).

Multiple types of IAT trigger events may be considered, for example:
a legacy UL transmission by the first UE or a legacy UL grant to the first UE. In this case, only UEs with active UL or granted/targeted during the regular onDuration can continue transmitting during the IAT.
a legacy any DL scheduling to the first UE, in case an UL response is needed shortly.
a legacy PUCCH/UCI transmission by a second UE in the cell.
a dedicated or group transmission [DCI or MAC CE] indicating an IAT trigger [explicit UL activity window extension signal].

In a particular embodiment, the UE may indicate in the UL whether it is not expecting further communication for the remainder of the IAT, and in response receiving from the NW an indication of early termination of the IAT. The indication can be based on PUCCH/PUSCH or PRACH or based on a sequence or RS. E.g., the UE may transmit a specific SRS indicating that it does not want IAT to be triggered.

In a particular embodiment, the UE may receive a configuration indicating the presence of at least an explicit field within one or more DCI formats ([0_1/1_1/0_2/1_2/ 2_X.]), and assessing at least one of whether an IAT trigger event has occurred or not occurred based on the value of the explicit field determined from a detected downlink control information, and adapting an IAT value based on the assessment.

An important objective in the UL is to efficiently to control when the UE is allowed to transmit on the PUCCH. PUSCH transmissions are always scheduled (either explicitly or with a dynamic grant) and PRACH transmissions can only occur in well-defined time windows. But the UE may transmit a scheduling request on the PUCCH at any time. One basic form of NW DTRX is that the preconfigured DL and UL transmission occasion patterns are gated by the gNB DRX and DTX on/offDuration patterns and any UE RX or TX occasions during offDuration are eliminated. The UE is then allowed to transmit e.g. SR during its SR occasions that occur during onDurations, and additionally their IAT extensions.

The IAT for PUCCH carrying the following signals may include following aspects:
HARQ ACK/NACK: The timing is known by the gNB and they should always be received by the gNB (the gNB RX-onDuration is automatically extended)
CSI feedback: The timing is known by the gNB and they should always be received (the gNB RX-onDuration is automatically extended). If these periodic CSI reports are not wanted, they can be removed. The IAT definition may include both options (i.e. whether to allow reporting after the end of the nominal onDuration or not). Aperiodic (scheduled) CSI reports may be configured for maximizing gNB EE.
Scheduling request: if there one active UE, monitoring for this prevent gNB DRX. Hence, they may only occur during the gNB RX-onDuration window. Another option is that an UL PUxCH transmission occurs during the onDuration that triggers the UL IAT and then the SR could be transmitted during the IAT extension. Alternatively the UE has two PUCCH configurations: One dedicated and one common, and which to use is triggered by the gNB. The common PUCCH is used when the gNB wants to maximize DRX.

In a particular embodiment, if a UE detects a DCI, regardless of DTRX indication, it shall follow the actions as per the detected DCI like transmitting HARQ feedback, and triggering the DRX RTT/re-transmission timers when the feedback is NACK, etc.

It may be desirable to define gNB DRX rules that work in a similar manner as the DRX rules for the UE. However, there are some differences:
PUCCH transmissions containing a scheduling request need to occur during the gNB RX-onDuration to have the intended effect. If that is not the case then the UE will sometimes transmit PUCCH that the gNB will ignore which may interfere with preferred UE operation. The UE may switch between a dedicated and a common DRX scheme, which could apply also for UE DTX (i.e. gNB DRX). E.g. the UE could have dedicated and common PUCCH resources defined and the NW can control which of the two the UE shall use.
PUCCH transmissions containing HARQ ACK/NACK or CSI feedback shall always be received by the gNB (i.e. the gNB RX-onDuration is always extended to receive these signals).
PUSCH transmissions that are explicitly scheduled should be received by the gNB, even if they occur outside of a gNB onDuration window. A protocol where the gNB provides a grant for UL transmission to a UE that the gNB does not intend to listen to should be avoided.
Whenever there is a PRACH window defined, the UE might assume that the gNB reception is on. There could be a RRC parameter controlling if this shall be allowed or not.
In dynamic TDD, a change in UL/DL allocation (signaled through e.g. dedicated DCI, group DCI, or RRC) should also affect the assumptions the UE makes on gNB RX-onDuration. There should be no signaling that a slot is UL if the gNB receiver is turned off in the new UL slots,

In NR there are also UL transmissions without a dynamic grant:
configured grant type 1: provided and activated by RRC
configured grant type 2: provided by RRC and activated/deactivated by PDCCH

Dynamic grants could possibly be affected by an additional rule for when the gNB will be receiving. But these grants are typically periodic and the gNB can consider the RX energy cost when they are activated. One way to handle these is to simply revoke the dynamic grant.

### Single Setting for DL and UL (Cell DTRX)

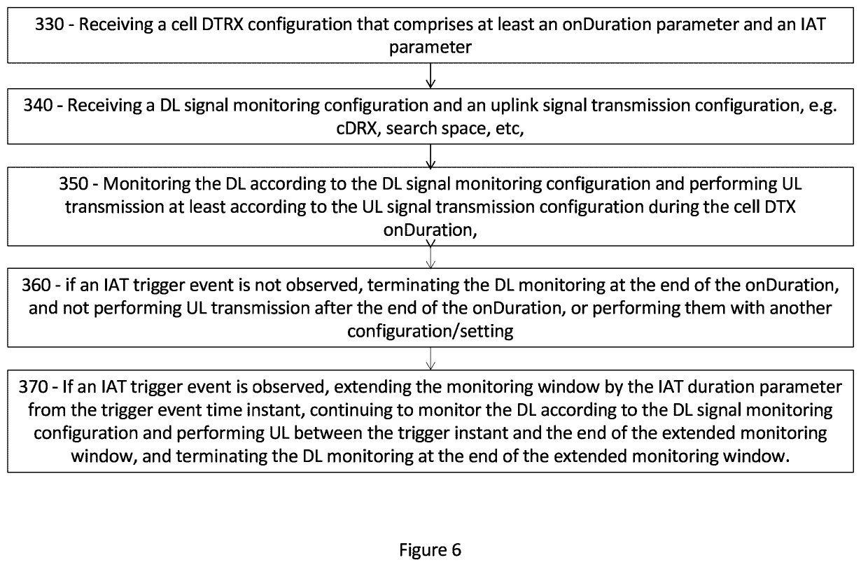

FIG. 6 illustrates an example method for cell DRX operation with IAT in a first UE when it is performing cell DTRX for both DL and UL using a single DTRX setting, onDuration and IAT, according to certain embodiments.

### Multi-CARRIER Operation

The gNB RX onDuration may cover more than one carrier. For a multi-carrier power amplifier (PA), there might not be much gain in treating some carriers independently. The UE may be configured with a list of carriers and then derive that if gNB reception is active on any of the carriers then they are active on all carriers in the list.

Then it may be preferable to align network DTRX configurations for such carriers. Both gNB DTX and DRX may be operating on a list of cells/carriers.

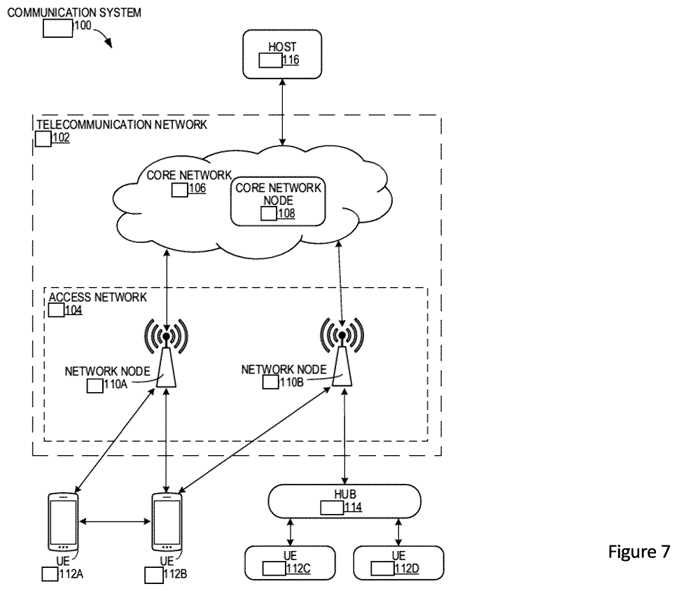

FIG. 7 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

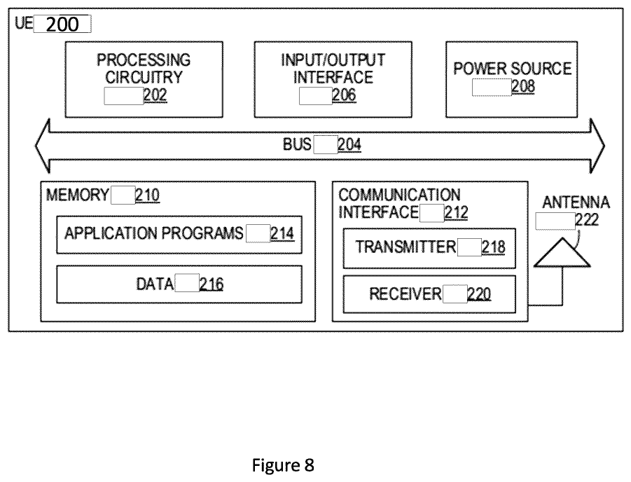

FIG. 8 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

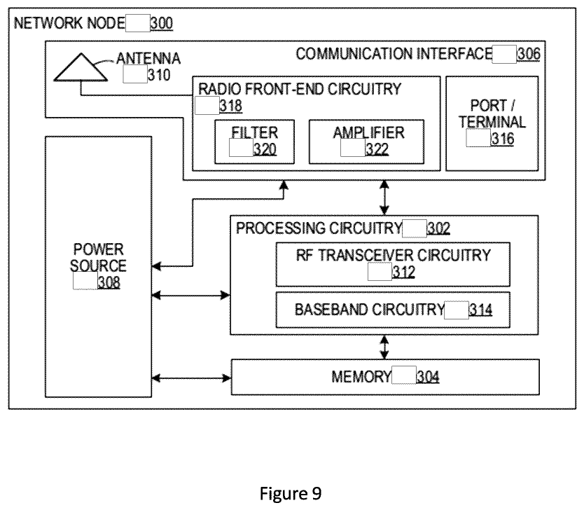

FIG. 9 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 9 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

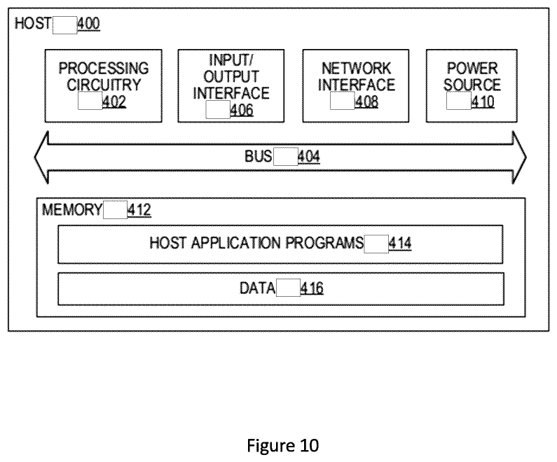

FIG. 10 is a block diagram of a host 400, which may be an embodiment of the host 116 of FIG. 7, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

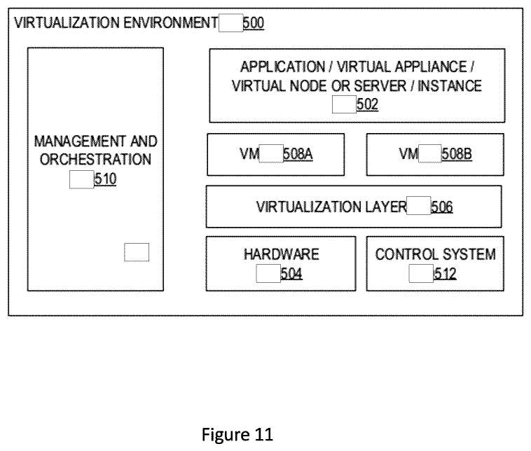

FIG. 11 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

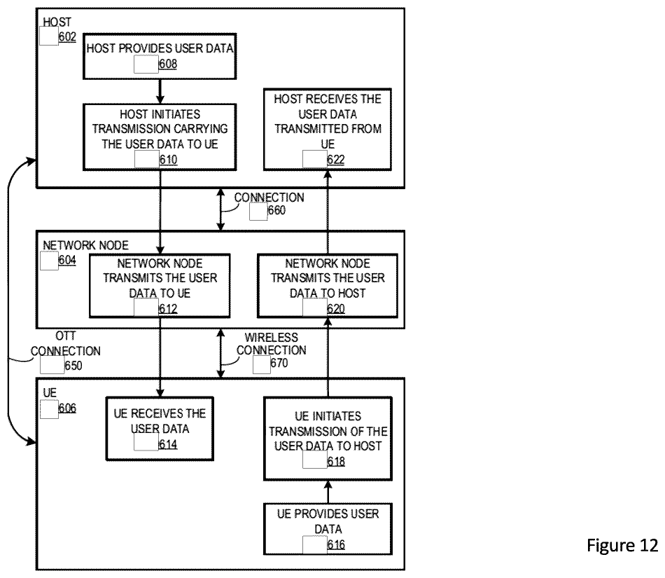

FIG. 12 shows a communication diagram of a host 602 communicating via a network node 604 with a UE 606 over a partially wireless connection in accordance with some embodiments. Example implementations, in accordance with various embodiments, of the UE (such as a UE 112a of FIG. 7 and/or UE 200 of FIG. 8), network node (such as network node 110a of FIG. 7 and/or network node 300 of FIG. 9), and host (such as host 116 of FIG. 7 and/or host 400 of FIG. 10) discussed in the preceding paragraphs will now be described with reference to FIG. 12.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 7) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc. ; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

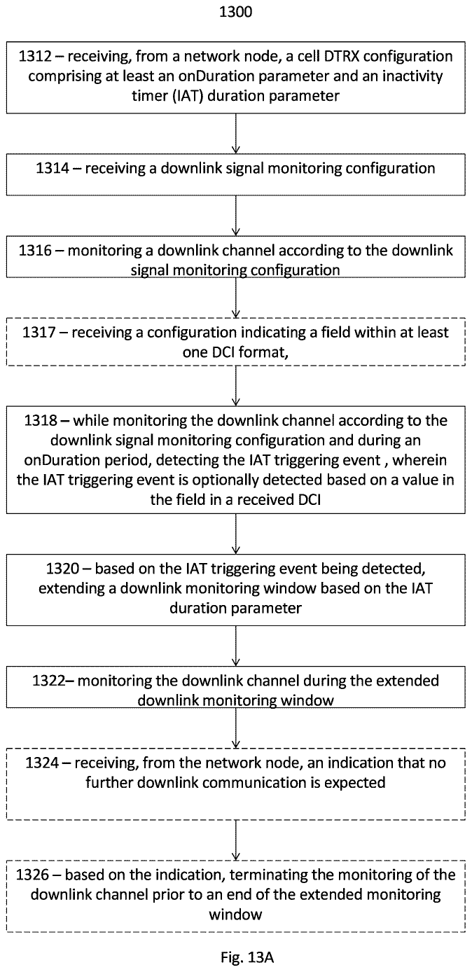

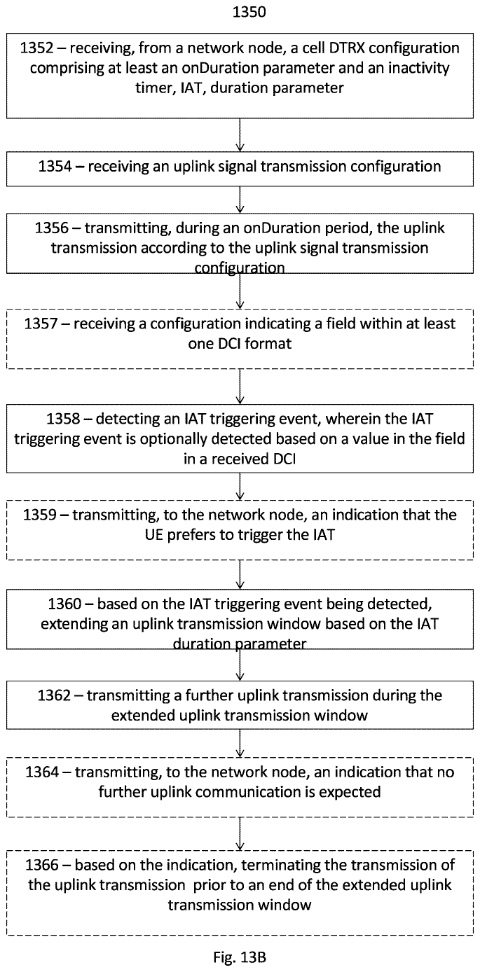

FIG. 13A is a flowchart illustrating an example method in a wireless device, according to certain embodiments. In particular embodiments, one or more steps of FIG. 13A may be performed by UE 200 described with respect to FIG. 8. The method is for signal reception in a cell using cell discontinuous transmission reception.

The method may begin at step 1312, where the wireless device (e.g., UE 200) receives, from a network node, a cell DTRX configuration comprising at least an onDuration parameter and an IAT duration parameter.

In particular embodiments, the onDuration parameter is the downlink monitoring window.

In particular embodiments, the cell DTRX configuration further comprises a cell DTX onDuration.

In particular embodiments, the IAT duration parameter comprises an amount of time for extending the downlink monitoring window. In particular embodiments, the amount of time for extending the downlink monitoring window initiates at a time instant associated with the detection of the IAT triggering event.

At step 1314, the wireless device receives a downlink signal monitoring configuration. In particular embodiments, the downlink signal monitoring configuration comprises at least one of connected mode DRX or search space.

At step 1316, the wireless device monitors a downlink channel according to the downlink signal monitoring configuration.

At step 1317, optionally, the wireless device receives a configuration indicating a field within at least one DCI format.

At step 1318, the wireless device, monitoring the downlink channel according to the downlink signal monitoring configuration and during an onDuration period, detects an IAT triggering event. In particular embodiments, the IAT triggering event may be optionally detected based on a value in the field in a received DCI.

At step 1320, the wireless device, based on the IAT triggering event being detected, extends a downlink monitoring window based on the IAT duration parameter.

At step 1322, the wireless device monitors the downlink channel during the extended downlink monitoring window.

At step 1324, optionally the wireless device receives, from the network node, an indication that no further downlink communication is expected. At step 1326, optionally the wireless device, based on the indication, terminates the monitoring of the downlink channel prior to an end of the extended monitoring window.

In particular embodiments, the cell DTRX configuration further comprises information indicating whether the IAT should be triggered or information indicating at least one activity in the downlink channel associated with the IAT triggering event.

In particular embodiments, the IAT triggering event comprises at least one of: a PDCCH and/or DCI transmission to the first UE in the cell; a PDCCH or DCI transmission to a second UE in the cell; a PDCCH or DCI transmission comprising scheduling new data; non-scheduling DCI; a downlink reference signal; a dedicated transmission indicating an IAT triggering event that triggers a preconfigured IAT duration; a broadcast transmission indicating an IAT triggering event that triggers a preconfigured IAT duration; a dedicated transmission indicating an IAT duration value; and a broadcast transmission indicating an IAT duration value.

Modifications, additions, or omissions may be made to method 1300 of FIG. 13A. Additionally, one or more steps in the method of FIG. 13A may be performed in parallel or in any suitable order.

FIG. 13B is a flowchart illustrating another example method in a wireless device, according to certain embodiments. In particular embodiments, one or more steps of FIG. 13B may be performed by UE 200 described with respect to FIG. 8. The method is for signal transmission in a cell using cell DTRX.

The method may begin at step 1352, where the wireless device (e.g., UE 200) receives, from a network node, a cell DTRX configuration comprising at least an onDuration parameter and an IAT duration parameter.

At step 1354, the wireless device receives an uplink signal transmission configuration.

At step 1356, the wireless device transmits, during an onDuration period, the uplink transmission according to the uplink signal transmission configuration.

At step 1357, optionally the wireless device receives a configuration indicating a field within at least one DCI format.

At step 1358, the wireless device detects an IAT triggering event. In particular embodiments, the IAT triggering event may be optionally detected based on a value in the field in a received DCI.

At step 1359, optionally the wireless device transmits, to the network node, an indication that the UE prefers to trigger the IAT.

At step 1360, the wireless device, based on the IAT triggering event being detected, extends an uplink transmission window based on the IAT duration parameter.

At step 1362, the wireless device transmits a further uplink transmission during the extended uplink transmission window. In particular embodiments, the further uplink transmission in step 1362 may be a continuation of the uplink transmission transmitted during the onDuration period in step 1365. In particular embodiments, the further uplink transmission in step 1362 may be different from the uplink transmission transmitted during the onDuration period in step 1365.

At step 1364, optionally the wireless device transmits, to the network node, an indication that no further uplink communication is expected. At step 1366, optionally the wireless device, based on the indication, the wireless device terminates the transmission of the uplink transmission prior to an end of the extended uplink transmission window.

In particular embodiments, the method may further comprise terminating the transmission of the uplink transmission at an end of the extended uplink monitoring window, e.g., regardless of an indication that no further uplink communication is needed or expected.

In particular embodiments, the onDuration parameter is the uplink monitoring window.

In particular embodiments, the cell DTRX configuration further comprises a cell DTX onDuration,

In particular embodiments, the IAT duration parameter comprises an amount of time for extending the uplink monitoring window. In particular embodiments, the amount of time for extending the uplink monitoring window initiates at a time instant associated with the detection of the IAT triggering event.

In particular embodiments, the uplink signal transmission configuration comprises at least one of an uplink grant and at least one transmission resource.

In particular embodiments, the cell DTRX configuration further comprises information indicating whether the IAT should be triggered or information indicating at least one activity associated with the IAT triggering event.

In particular embodiments, the IAT triggering event comprises at least one of: a legacy uplink transmission by the first UE; a legacy uplink grant to the first UE; downlink scheduling to the first UE; a PDCCH or DCI transmission by the first UE in the cell; a PUCCH or UCI transmission by a second UE in the cell; a dedicated transmission indicating the IAT triggering event; and a broadcast transmission indicating the IAT triggering event.

Modifications, additions, or omissions may be made to method 1350 of FIG. 13B. Additionally, one or more steps in the method of FIG. 13B may be performed in parallel or in any suitable order.

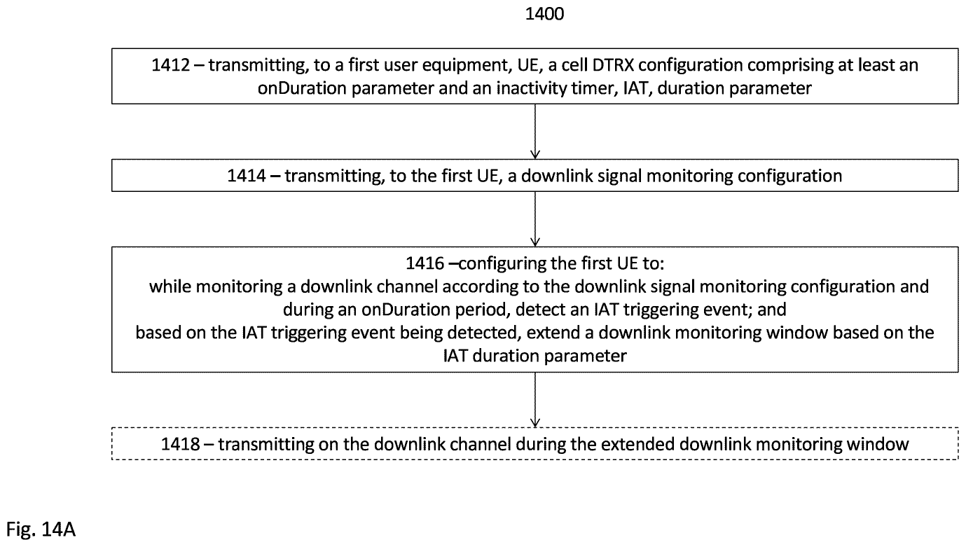

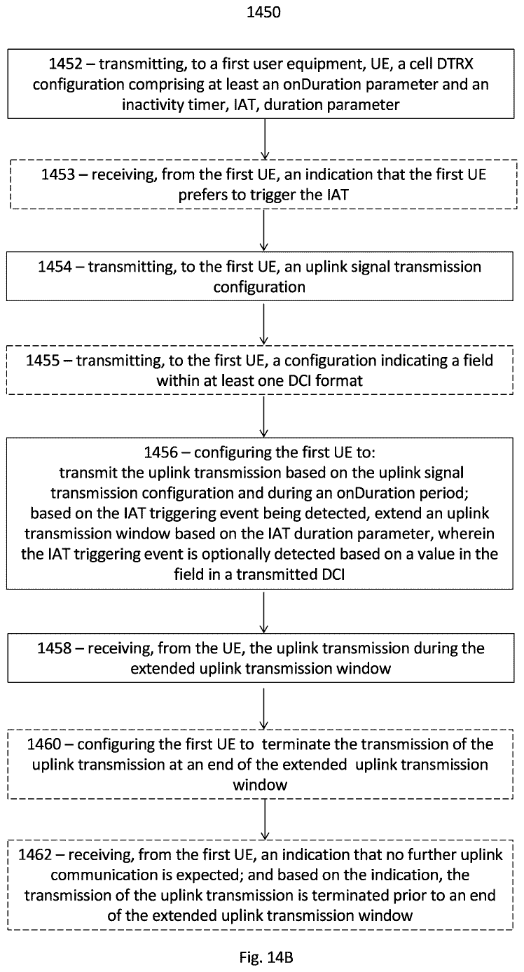

FIG. 14A is a flowchart illustrating an example method in a network node, according to certain embodiments. In particular embodiments, one or more steps of FIG. 14A may be performed by network node 300 described with respect to FIG. 9. The method is for configuring a user equipment for signal transmission or reception in a cell using cell discontinuous transmission reception, DTRX.

The method begins at step 1412, where the network node (e.g., network node 300) transmits to a first user equipment, UE, a cell DTRX configuration comprising at least an onDuration parameter and an inactivity timer, IAT, duration parameter.

At step 1414, the network node transmits to the first UE, a downlink signal monitoring configuration. At step 1416, the network node configures the first UE to, while monitoring a downlink channel according to the downlink signal monitoring configuration and during an onDuration period, detect an IAT triggering event; and based on the IAT triggering event being detected, extend a downlink monitoring window based on the IAT duration parameter.

At step 1418, the network node transmits on the downlink channel during the extended downlink monitoring window.

In particular embodiments, the onDuration parameter is the downlink monitoring window.

In particular embodiments, the cell DTRX configuration further comprises a cell DTX onDuration.

In particular embodiments, the IAT duration parameter comprises an amount of time for extending the downlink monitoring window. In particular embodiments, the amount of time for extending the downlink monitoring window initiates at a time instant associated with the detection of the IAT triggering event.

In particular embodiments, the downlink signal monitoring configuration comprises at least one of connected mode DRX or search space.

In particular embodiments, the cell DTRX configuration further comprises information indicating whether the IAT should be triggered or information indicating at least one activity in the downlink channel associated with the IAT triggering event.

In particular embodiments, the IAT triggering event comprises at least one of: a PDCCH or DCI transmission to the first UE in the cell; a PDCCH or DCI transmission to a second UE in the cell; a PDCCH or DCI transmission comprising scheduling new data; non-scheduling DCI; a downlink reference signal; a dedicated transmission indicating an IAT triggering event that triggers a preconfigured IAT duration; a broadcast transmission indicating an IAT triggering event that triggers a preconfigured IAT duration; a dedicated transmission indicating an IAT duration value; and a broadcast transmission indicating an IAT duration value.

In particular embodiments, the network node comprises a gNodeB (gNB).

Modifications, additions, or omissions may be made to method 1400 of FIG. 14A. Additionally, one or more steps in the method of FIG. 14A may be performed in parallel or in any suitable order.

FIG. 14B is a flowchart illustrating an example method in a network node, according to certain embodiments. In particular embodiments, one or more steps of FIG. 14B may be performed by network node 300 described with respect to FIG. 9.

The method begins at step 1452, where the network node (e.g., network node 300) transmits to a first UE a cell DTRX configuration comprising at least an onDuration parameter and an inactivity timer, IAT, duration parameter.

At step 1453, optionally the network node receives, from the first UE, an indication that the first UE prefers to trigger the IAT. At step 1454, the network node transmits, to the first UE, an uplink signal transmission configuration.

At step 1455, optionally the network node transmits, to the first UE, a configuration indicating a field within at least one DCI format.

At step 1456, the network node configures the first UE to transmit the uplink transmission based on the uplink signal transmission configuration and during an onDuration period; and, based on the IAT triggering event being detected, extends an uplink transmission window based on the IAT duration parameter. In particular embodiments, the IAT triggering event may be optionally detected based on a value in the field in a transmitted DCI.

At step 1458, the network node receives, from the UE, the uplink transmission during the extended uplink transmission window.

At step 1460, optionally the network node may configure the first UE to terminate the transmission of the uplink transmission at an end of the extended uplink transmission window.

At step 1462, optionally the network node may receive, from the first UE, an indication that no further uplink communication is expected; and based on the indication, the transmission of the uplink transmission is terminated prior to an end of the extended uplink transmission window.

In particular embodiments, the onDuration parameter is the uplink monitoring window.

In particular embodiments, the cell DTRX configuration further comprises a cell DTX onDuration.

In particular embodiments, the IAT duration parameter comprises an amount of time for extending the uplink monitoring window. In particular embodiments, the amount of time for extending the uplink monitoring window initiates at a time instant associated with the detection of the IAT triggering event.

In particular embodiments, the uplink signal transmission configuration comprises at least one of an uplink grant and/or at least one transmission resource.

In particular embodiments, the cell DTRX configuration further comprises information indicating whether the IAT should be triggered or information indicating at least one activity associated with the IAT triggering event.

In particular embodiments, the IAT triggering event comprises at least one of: a legacy uplink transmission by the first UE; a legacy uplink grant to the first UE; downlink scheduling to the first UE; a PUCCH or UCI transmission by the first UE in the cell; a PUCCH or UCI transmission by a second UE in the cell; a dedicated transmission indicating the IAT triggering event; and a broadcast transmission indicating the IAT triggering event.

In particular embodiments, the network node comprises a gNodeB (gNB).

Modifications, additions, or omissions may be made to method 1450 of FIG. 14B. Additionally, one or more steps in the method of FIG. 14B may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

### EXAMPLE EMBODIMENTS

### Group a Example Embodiments

Example Embodiment A1. A method by a user equipment (UE) for signal transmission and/or reception in a cell utilizing DTRX, the method comprising:
any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising:
providing user data; and
forwarding the user data to a host computer via the transmission to the network node.

### Group B Example Embodiments

Example Embodiment B1. A method performed by a network node for configuring a user equipment for signal transmission and/or reception in a cell utilizing DTRX, the method comprising:
any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising:
obtaining user data; and
forwarding the user data to a host or a user equipment.

### Group C Example Embodiments

Example Embodiment C1. A method by a first user equipment (UE) for signal reception in a cell utilizing DTRX, the method comprising:
receiving, from a network node, a cell DTRX configuration comprising at least an onDuration parameter and an IAT duration parameter;
receiving a downlink signal monitoring configuration;
while monitoring a downlink channel based on the downlink signal monitoring configuration and during a downlink monitoring window, detecting an IAT triggering event; and
based on the IAT triggering event being detected, extending the downlink monitoring window based on the IAT duration parameter; and
monitoring the downlink channel during the extended downlink monitoring window.

Example Embodiment C2. The method of Example Embodiment C1, wherein the onDuration parameter is the downlink monitoring window.

Example Embodiment C3. The method of any one of Example Embodiments C1 to C2, wherein the downlink monitoring window comprises a cell DTX onDuration.

Example Embodiment C4. The method of any one of Example Embodiments C1 to C3, wherein the IAT duration parameter comprises an amount of time for extending the downlink monitoring window.

Example Embodiment C5. The method of Example Embodiment C4, wherein the amount of time for extending the downlink monitoring window initiates at a time instant associated with the detection of the IAT triggering event.

Example Embodiment C6. The method of any one of Example Embodiments C1 to C5, wherein the downlink signal monitoring configuration comprises a cDRX search space.

Example Embodiment C7. The method of any one of Example Embodiments C1 to C6,comprising: terminating the monitoring of the downlink channel at an end of the extended monitoring window.

Example Embodiment C8. The method of any one of Example Embodiments C1 to C6, comprising: receiving, from the network node, an indication that no further downlink communication is expected; and based on the indication, terminating the monitoring of the downlink channel prior to an end of the extended monitoring window.

Example Embodiment C9. The method of any one of Example Embodiments C1 to C8, wherein the DTRX configuration comprises a cell DTX parameter.

Example Embodiment C10. The method of any one of Example Embodiments C1 to C9, wherein the DTRX configuration comprises information indicating whether IAT shall be triggered and/or at least one activity associated with the IAT triggering event.

Example Embodiment C11. The method of any one of Example Embodiments C1 to C10, wherein the IAT triggering event comprises at least one of:
a PDCCH and/or DCI transmission to the first UE in the cell;
a PDCCH and/or DCI transmission to a second UE in the cell;
a PDCCH and/or DCI transmission comprising scheduling new data;
non-scheduling DCI;
a downlink reference signal;
a dedicated transmission indicating an IAT triggering event that triggers a preconfigured IAT duration;
a broadcast transmission indicating an IAT triggering event that triggers a preconfigured IAT duration;
a dedicated transmission indicating an IAT duration value; and
a broadcast transmission indicating an IAT duration value.

Example Embodiment C12. The method of any one of Example Embodiments C1 to C11, comprising receiving a configuration indicating a field within at least one DCI format, and wherein the IAT triggering event is detected based on a value in the field in a received DCI.

Example Embodiment C13. The method of Example Embodiments C1 to C12, further comprising:
providing user data; and
forwarding the user data to a host via the transmission to the network node.

Example Embodiment C14. A user equipment configured to perform any of the methods of Example Embodiments C1 to C13.

Example Embodiment C15. A user equipment comprising processing circuitry configured to perform any of the methods of Example Embodiments C1 to C13.

Example Embodiment C16. A wireless device comprising processing circuitry configured to perform any of the methods of Example Embodiments C1 to C13.

Example Embodiment C17. A computer program comprising instructions which when executed on a computer perform any of the methods of Example Embodiments C1 to C13.

Example Embodiment C18. A computer program product comprising computer program, the computer program comprising instructions which when executed on a computer perform any of the methods of Example Embodiments C1 to C13.

Example Embodiment C19. A non-transitory computer readable medium storing instructions which when executed by a computer perform any of the methods of Example Embodiments C1 to C13.

### Group D Example Embodiments

Example Embodiment D1. A method by a first user equipment (UE) for signal transmission in a cell utilizing DTRX, the method comprising:
receiving, from a network node, a cell DTRX configuration comprising at least an onDuration parameter and an IAT duration parameter;
receiving an uplink signal transmission configuration;
transmitting the uplink transmission based on the uplink signal transmission configuration and the onDuration parameter;
based on the IAT triggering event being detected, extending the uplink transmission window based on the IAT duration parameter; and
transmitting the uplink transmission during the extended uplink transmission window.

Example Embodiment D2. The method of Example Embodiment D1, wherein the onDuration parameter is the uplink transmission window.

Example Embodiment D3. The method of any one of Example Embodiments D1 to D2, wherein the uplink transmission window comprises a cell DTX onDuration.

Example Embodiment D4. The method of any one of Example Embodiments D1 to D3, wherein the IAT duration parameter comprises an amount of time for extending the uplink transmission window.

Example Embodiment D5. The method of Example Embodiment D4, wherein the amount of time for extending the uplink transmission window initiates at a time instant associated with the detection of the IAT triggering event.

Example Embodiment D6. The method of any one of Example Embodiments D1 to D5, wherein the uplink signal transmission configuration comprises at least one of: an uplink grant and/or at least one transmission resource.

Example Embodiment D7. The method of any one of Example Embodiments D1 to D6, comprising: terminating the transmission of the uplink transmission at an end of the extended uplink transmission window.

Example Embodiment D8. The method of any one of Example Embodiments DI to D6, comprising: transmitting, to the network node, an indication that no further uplink communication is expected; and based on the indication, terminating the transmission of the uplink transmission prior to an end of the extended uplink transmission window.

Example Embodiment D9. The method of any one of Example Embodiments D1 to D8, comprising: transmitting, to the network node, an indication that the UE prefers to trigger the IAT.

Example Embodiment D10. The method of any one of Example Embodiments D1 to D9, wherein the DTRX configuration comprises a cell DTX parameter.

Example Embodiment D11. The method of any one of Example Embodiments D1 to D10, wherein the DTRX configuration comprises information indicating whether IAT shall be triggered and/or at least one activity associated with the IAT triggering event.

Example Embodiment D12. The method of any one of Example Embodiments D1 to D11, wherein the IAT triggering event comprises at least one of:
a legacy uplink transmission by the first UE;
a legacy uplink grant to the first UE;
downlink scheduling to the first UE;
a PUCCH and/or UCI transmission by the first UE in the cell;
a PUCCH and/or UCI transmission by a second UE in the cell;
a dedicated transmission indicating the IAT triggering event; and
a broadcast transmission indicating the IAT triggering event.

Example Embodiment D13. The method of any one of Example Embodiments D1 to D12, comprising receiving a configuration indicating a field within at least one DCI format, and wherein the IAT triggering event is detected based on a value in the field in a received DCI.

Example Embodiment D14. The method of Example Embodiments C1 to C13, further comprising:
providing user data; and
forwarding the user data to a host via the transmission to the network node.

Example Embodiment D15. A user equipment configured to perform any of the methods of Example Embodiments D1 to D14.

Example Embodiment D16. A user equipment comprising processing circuitry configured to perform any of the methods of Example Embodiments D1 to D14.

Example Embodiment D17. A wireless device comprising processing circuitry configured to perform any of the methods of Example Embodiments D1 to D14.

Example Embodiment D18. A computer program comprising instructions which when executed on a computer perform any of the methods of Example Embodiments D1 to D14.

Example Embodiment D19. A computer program product comprising computer program, the computer program comprising instructions which when executed on a computer perform any of the methods of Example Embodiments D1 to D14.

Example Embodiment D20. A non-transitory computer readable medium storing instructions which when executed by a computer perform any of the methods of Example Embodiments D1 to D14.

### Group E Example Embodiments

Example Embodiment E1. A method by a network node for configuring a user equipment for signal transmission and/or reception in a cell utilizing DTRX, the method comprising:
transmitting, to a UE, a cell DTRX configuration comprising at least an onDuration parameter and an IAT duration parameter;
transmitting, to the UE, a downlink signal monitoring configuration;
configuring the UE to:
   while monitoring a downlink channel based on the downlink signal monitoring configuration and during a downlink monitoring window, detect an IAT triggering event; and
   based on the IAT triggering event being detected, extend the downlink monitoring window based on the IAT duration parameter; and
wherein the method further comprises transmitting on the downlink channel during the extended downlink monitoring window.

Example Embodiment E2. The method of Example Embodiment E1, wherein the onDuration parameter is the downlink monitoring window.

Example Embodiment E3. The method of any one of Example Embodiments E1 to E2, wherein the downlink monitoring window comprises a cell DTX onDuration.

Example Embodiment E4. The method of any one of Example Embodiments E1 to E3, wherein the IAT duration parameter comprises an amount of time for extending the downlink monitoring window.

Example Embodiment E5. The method of Example Embodiment E4, wherein the amount of time for extending the downlink monitoring window initiates at a time instant associated with the detection of the IAT triggering event.

Example Embodiment E6. The method of any one of Example Embodiments E1 to E5, wherein the downlink signal monitoring configuration comprises a cDRX search space.

Example Embodiment E7. The method of any one of Example Embodiments E1 to E6, comprising configuring the UE to terminate the monitoring of the downlink channel at an end of the extended monitoring window.

Example Embodiment E8. The method of any one of Example Embodiments E1 to E6, comprising: transmitting to the UE an indication that no further downlink communication is expected; and wherein the UE is configured to, based on the indication, terminate the monitoring of the downlink channel prior to an end of the extended monitoring window.

Example Embodiment E9. The method of any one of Example Embodiments E1 to E8, wherein the DTRX configuration comprises a cell DTX parameter.

Example Embodiment E10. The method of any one of Example Embodiments E1 to E9, wherein the DTRX configuration comprises information indicating whether IAT shall be triggered and/or at least one activity associated with the IAT triggering event.

Example Embodiment E11. The method of any one of Example Embodiments E1 to E10, wherein the IAT triggering event comprises at least one of:
a PDCCH and/or DCI transmission to the first UE in the cell;
a PDCCH and/or DCI transmission to a second UE in the cell;
a PDCCH and/or DCI transmission comprising scheduling new data;
non-scheduling DCI;
a downlink reference signal;
a dedicated transmission indicating an IAT triggering event that triggers a preconfigured IAT duration;
a broadcast transmission indicating an IAT triggering event that triggers a preconfigured IAT duration;
a dedicated transmission indicating an IAT duration value; and
a broadcast transmission indicating an IAT duration value.

Example Embodiment E12. The method of any one of Example Embodiments E1 to E11, comprising transmitting, to the UE, a configuration indicating a field within at least one DCI format, and wherein the IAT triggering event is detected based on a value in the field in a received DCI.

Example Embodiment E13. The method of any one of Example Embodiments E1 to E12, wherein the network node comprises a gNodeB (gNB).

Example Embodiment E14. The method of any of the previous Example Embodiments, further comprising:
obtaining user data; and
forwarding the user data to a host or a user equipment.

Example Embodiment E15. A network node comprising processing circuitry configured to perform any of the methods of Example Embodiments E1 to E14.

Example Embodiment E16. A network node configured to perform any of the methods of Example Embodiments El to E14.

Example Embodiment E17. A computer program comprising instructions which when executed on a computer perform any of the methods of Example Embodiments E1 to E14.

Example Embodiment E18. A computer program product comprising computer program, the computer program comprising instructions which when executed on a computer perform any of the methods of Example Embodiments E1 to E14.

Example Embodiment E19. A non-transitory computer readable medium storing instructions which when executed by a computer perform any of the methods of Example Embodiments E1 to E14.

### Group F Example Embodiments

Example Embodiment F1. A method by a network node for configuring a user equipment for signal transmission and/or reception in a cell utilizing DTRX, the method comprising:
transmitting, to the UE, a cell DTRX configuration comprising at least an onDuration parameter and an IAT duration parameter;
transmitting, to the UE, an uplink signal transmission configuration;
configuring the UE to:
   transmit the uplink transmission based on the uplink signal transmission configuration and the onDuration parameter;
   based on the IAT triggering event being detected, extend the uplink transmission window based on the IAT duration parameter; and
wherein the method further comprises receiving, from the UE, the uplink transmission during the extended uplink transmission window.

Example Embodiment F2. The method of Example Embodiment F1, wherein the onDuration parameter is the uplink transmission window.

Example Embodiment F3. The method of any one of Example Embodiments F1 to F2, wherein the uplink transmission window comprises a cell DTX onDuration.

Example Embodiment F4. The method of any one of Example Embodiments F1 to F3, wherein the IAT duration parameter comprises an amount of time for extending the uplink transmission window.

Example Embodiment F5. The method of Example Embodiment F4, wherein the amount of time for extending the uplink transmission window initiates at a time instant associated with the detection of the IAT triggering event.

Example Embodiment F6. The method of any one of Example Embodiments F1 to F5, wherein the uplink signal transmission configuration comprises at least one of: an uplink grant and/or at least one transmission resource.

Example Embodiment F7. The method of any one of Example Embodiments F1 to F6, comprising configuring the UE to terminate the transmission of the uplink transmission at an end of the extended uplink transmission window.

Example Embodiment F8. The method of any one of Example Embodiments F1 to F6, comprising: receiving, from the UE, an indication that no further uplink communication is expected; and wherein the UE is configured, based on the indication, to terminate the transmission of the uplink transmission prior to an end of the extended uplink transmission window.

Example Embodiment F9. The method of any one of Example Embodiments F1 to F8, comprising: receiving, from the UE, an indication that the UE prefers to trigger the IAT.

Example Embodiment F10. The method of any one of Example Embodiments F1 to F9, wherein the DTRX configuration comprises a cell DTX parameter.

Example Embodiment F11. The method of any one of Example Embodiments F1 to F10, wherein the DTRX configuration comprises information indicating whether IAT shall be triggered and/or at least one activity associated with the IAT triggering event.

Example Embodiment F12. The method of any one of Example Embodiments F1 to F11, wherein the IAT triggering event comprises at least one of:
a legacy uplink transmission by the first UE;
a legacy uplink grant to the first UE;
downlink scheduling to the first UE;
a PUCCH and/or UCI transmission by the first UE in the cell;
a PUCCH and/or UCI transmission by a second UE in the cell;
a dedicated transmission indicating the IAT triggering event; and
a broadcast transmission indicating the IAT triggering event.

Example Embodiment F13. The method of any one of Example Embodiments F1 to F12, comprising transmitting, to the UE, a configuration indicating a field within at least one DCI format, and wherein the UE is configured to detect the IAT triggering event based on a value in the field in a received DCI.

Example Embodiment F14. The method of any one of Example Embodiments F1 to F13, wherein the network node comprises a gNodeB (gNB).

Example Embodiment F15. The method of any of the previous Example Embodiments, further comprising:
obtaining user data; and
forwarding the user data to a host or a user equipment.

Example Embodiment F16. A network node comprising processing circuitry configured to perform any of the methods of Example Embodiments F1 to F15.

Example Embodiment F17. A network node configured to perform any of the methods of Example Embodiments F1 to F15.

Example Embodiment F18. A computer program comprising instructions which when executed on a computer perform any of the methods of Example Embodiments F1 to F15.

Example Embodiment F19. A computer program product comprising computer program, the computer program comprising instructions which when executed on a computer perform any of the methods of Example Embodiments Fl to F15.

Example Embodiment F20. A non-transitory computer readable medium storing instructions which when executed by a computer perform any of the methods of Example Embodiments F1 to F15.

### Group G Example Embodiments

Example Embodiment G1. A user equipment comprising:
processing circuitry configured to perform any of the steps of any of the Group A, C, and D Example Embodiments; and
power supply circuitry configured to supply power to the processing circuitry.

Example Embodiment G2. A network node comprising:
processing circuitry configured to perform any of the steps of any of the Group B, E, and F Example Embodiments;
power supply circuitry configured to supply power to the processing circuitry.

Example Embodiment G3. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A, C, and D Example Embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Example Embodiment G4. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A, C, and D Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment G7. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Example Embodiment G8. The method of the previous Example Embodiment, further comprising:
at the host, executing a host application associated with a client application executing on the UE to receive the user data from the UE.

Example Embodiment G9. The method of the previous Example Embodiment, further comprising:
at the host, transmitting input data to the client application executing on the UE, the input data being provided by executing the host application,
wherein the user data is provided by the client application in response to the input data from the host application.

Example Embodiment G10. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A, C, and D Example Embodiments to transmit the user data to the host.

Example Embodiment G11. The host of the previous Example Embodiment, wherein the cellular network further includes a network node configured to communicate with the UE to transmit the user data from the UE to the host.

Example Embodiment G 12. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment G13. A method implemented by a host configured to operate in a communication system that further includes a network node and a user equipment (UE), the method comprising:
at the host, receiving user data transmitted to the host via the network node by the UE, wherein the UE performs any of the steps of any of the Group A, C, and D Example Embodiments to transmit the user data to the host.

Example Embodiment G14. The method of the previous Example Embodiment, further comprising:
at the host, executing a host application associated with a client application executing on the UE to receive the user data from the UE.

Example Embodiment G15. The method of the previous Example Embodiment, further comprising:
at the host, transmitting input data to the client application executing on the UE, the input data being provided by executing the host application,
wherein the user data is provided by the client application in response to the input data from the host application.

Example Embodiment G16. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B, E, and F Example Embodiments to transmit the user data from the host to the UE.

Example Embodiment G17. The host of the previous Example Embodiment, wherein:
the processing circuitry of the host is configured to execute a host application that provides the user data; and
the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B, E, and F Example Embodiments to transmit the user data from the host to the UE.

Example Embodiment G19. The method of the previous Example Embodiment, further comprising, at the network node, transmitting the user data provided by the host for the UE.

Example Embodiment G 20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B, E, and F Example Embodiments to transmit the user data from the host to the UE.

Example Embodiment G22. The communication system of the previous Example Embodiment, further comprising:
the network node; and/or
the user equipment.

Example Embodiment G23. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B, E, and F Example Embodiments to receive the user data from a user equipment (UE) for the host.

Example Embodiment G 24. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment G 25. The host of the any of the previous 2 Example Embodiments, wherein the initiating receipt of the user data comprises requesting the user data.

Example Embodiment G26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B, E, and F Example Embodiments to receive the user data from the UE for the host.

Example Embodiment G27. The method of the previous Example Embodiment, further comprising at the network node, transmitting the received user data to the host.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1x RTT CDMA2000 1x Radio Transmission Technology
3GPP 3rd Generation Partnership Project
5G 5th Generation
5GC 5G Core
5GS 5G System
5QI 5G QoS Identifier
6G 6^{th} Generation
ABS Almost Blank Subframe
AN Access Network
AN Access Node
ANR Automatic Neighbor Relations
AP Access Point
ARQ Automatic Repeat Request
AS Access Stratum
ASN.1 Abstract Syntax Notation One
AWGN Additive White Gaussian Noise
BCCH Broadcast Control Channel
BCH Broadcast Channel
BLER Block Error Rate
bps Bits per second
BS Base Station
BSC Base Station Controller
BTS Base Transceiver Station
CA Carrier Aggregation
CB Contention-Based
CBRA Contention-Based Random Access
CC Carrier Component
CCCH SDU Common Control Channel SDU
CDM Code Division Multiplexing
CDMA Code Division Multiplexing Access
CE Control Element/Coverage Enhancement
CF Contention-Free
CFRA Contention-Free Random Access
CG Cell Group
CGI Cell Global Identifier/Identity
CIR Channel Impulse Response
CN Core Network
CP Cyclic Prefix
CPICH Common Pilot Channel
CPICH Ec/No CPICH Received energy per chip divided by the power density in the band
CQI Channel Quality information
C-RNTI Cell RNTI
CRC Cyclic Redundancy Check
CRM Contention Resolution Message
C-RNTI Cell RNTI
CSI Channel State Information
CSI-RS Channel State Information Reference Signal
DCCH Dedicated Control Channel
DCI Downlink Control Information
DL Downlink
DL-SCH Downlink Shared Channel
DM Demodulation
DMRS Demodulation Reference Signal
DRX Discontinuous Reception
DTX Discontinuous Transmission
DTCH Dedicated Traffic Channel
DUT Device Under Test
EARFCN Evolved Absolute Radio Frequency Channel Number
E-CID Enhanced Cell-ID (positioning method)
ECGI Evolved CGI
E-SMLC Evolved-Serving Mobile Location Centre
ECGI Evolved CGI
eDRX Enhanced DRX
EDT Early Data Transmission
eMBB Enhanced Mobile Broadband
eMBMS evolved Multimedia Broadcast Multicast Services
eMTC Enhanced Machine Type Communication
eNB E-UTRAN NodeB/eNodeB
ePDCCH enhanced Physical Downlink Control Channel
EPC Evolved Packet Core
EPS Evolved Packet System
E-UTRA Evolved UTRA
E-UTRAN Evolved Universal Terrestrial Radio Access Network
EVT Ephemeris data Validity Timer/Ephemeris Validity Timer
FDD Frequency Division Duplex
FDM Frequency Division Multiplexing
FFS For Further Study
FR Frequency Range
GERAN GSM EDGE Radio Access Network
GEO Geostationary Earth Orbit
GHz Gigahertz
GLONASS Global Navigation Satellite System
gNB gNode B (a base station in NR; a Node B supporting NR and
GNSS Global Navigation Satellite System
GPS Global Positioning System
GSM Global System for Mobile communication
GW Gateway
HAPS High Altitude Platform System/High Altitude Platform Station
HARQ Hybrid Automatic Repeat Request
HIBS HAPS as IMT Base Station
HO Handover
HSPA High Speed Packet Access
HRPD High Rate Packet Data
Hz Hertz
ID Identity/Identifier
IoT Internet of Things
IMT International Mobile Telecommunications
kHz Kilohertz
LEO Low Earth Orbit
LOS Line of Sight
LPP LTE Positioning Protocol
LTE Long-Term Evolution
LTE-M LTE-Machine Type Communication
LSB Least Significant Bit
M2M Machine to Machine
MAC Medium Access Control
MAC CE MAC Control Element
MBB Mobile Broadband
MBMS Multimedia Broadcast Multicast Services
MBSFN Multimedia Broadcast multicast service Single Frequency Network
MBSFN ABS MBSFN Almost Blank Subframe
MCS Modulation and Coding Scheme
MDT Minimization of Drive Tests
MEO Medium Earth Orbit
μs Microsecond
MIB Master Information Block
MME Mobility Management Entity
mMTC Massive Machine Type Communication
MRTD Maximum Receive Timing Difference
ms Millisecond
MSB Most Significant Bit
MSC Mobile Switching Center
Msg Message
Msg1 Message 1
Msg2 Message 2
Msg3 Message 3
Msg4 Message 4
Msg5 Message 5
MsgA Message A
MsgB Message B
MTC Machine Type Communication
NB-IoT Narrowband Internet of Things
NG The interface between the RAN and the core network in 5G/NR
NGC Next Generation Core
NGc The control plane part of NG
NGu The user plane part of NG
NPDCCH Narrowband Physical Downlink Control Channel
NPRACH NB-IoT Physical Random Access Channel
NR New Radio
NTN Non-Terrestrial Network
OCNG OFDMA Channel Noise Generator
OFDM Orthogonal Frequency Division Multiplexing
OFDMA Orthogonal Frequency Division Multiple Access
OSI Other System Information
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PCH Paging Channel
PCI Physical Cell Identity/Identifier
PDCCH Physical Downlink Control Channel
PDCP Packet Data Convergence Protocol
PDP Profile Delay Profile
PDSCH Physical Downlink Shared Channel
PDU Packet Data Unit
PGW Packet Gateway
PHICH Physical Hybrid-ARQ Indicator Channel
PLMN Public Land Mobile Network
PMI Precoder Matrix Indicator
PO PUSCH Occasion
PRACH Physical Random Access Channel
PRB Physical Resource Block
PRS Positioning Reference Signal
PS Packet Switched
PSCell Primary Secondary Cell
PSC Primary serving Cell
PSS Primary Synchronization Signal
PUCCH Physical Uplink Control Channel
PUR Pre-configured Uplink Resources
PUSCH Physical Uplink Shared Channel
QAM Quadrature Amplitude Modulation
RA Random Access
RACH Random Access Channel
RAB Radio Access Bearer
RAN Radio Access Network
RANAP Radio Access Network Application Part
RAR Random Access Response
RAT Radio Access Technology
RF Radio Frequency
RLC Radio Link Control
RLM Radio Link Monitoring
RMSI Remaining Minimum System Information
RMTC RSSI Measurement Timing Configuration
RNC Radio Network Controller
RNTI Radio Network Temporary Identifier
RO RACH Occasion (equivalent to PRACH occasion)
RRC Radio Resource Control
RRM Radio Resource Management
RRH Remote Radio Head
RRU Remote Radio Unit
RS Reference Signal
RSCP Received Signal Code Power
RSRP Reference Signal Received Power
RSRQ Reference Signal Received Quality
RSSI Received Signal Strength Indicator
RSTD Reference Signal Time Difference
RTT Roundtrip Time
RU Resource Unit
RV Redundancy Version
RX Receiver
RWR Release with Redirect
SCC Secondary Component Carrier
SCH Synchronization Channel
SCell Secondary Cell
SCG Secondary Cell Group
SCS Subcarrier Spacing
SCAP Service Data Adaptation Protocol
SDU Service Data Unit
SeNB Secondary eNodeB
SFN System Frame Number
SFTD SFN and Frame Timing Difference
SGW Serving Gateway
SI System Information or Study Item
SIE System Information Block
SIB1 System Information Block Type 1
SID Study Item Description
SINR Signal to Interference and Noise Ratio
SMTC SSB Measurement Timing Configuration
SNR Signal to Noise Ratio
S-NSSAI Single Network Slice Selection Assistance Information
SON Self Organizing Network
SRS Sounding Reference Signal
SS Synchronization Signal
SSB Synchronization Signal Block
SSC Secondary Serving Cell
SSS Secondary Synchronization Signal
TA Timing Advance
TAT Time Alignment Timer
TBS Transport Block Size
TDD Time Division Duplex
TDOA Time Difference of Arrival
TDM Time Division Multiplexing
TLE Two-Line Element Set/Two-Line Element
TOA Time of Arrival
TR Technical Report
TS Technical Specification
TSS Tertiary Synchronization Signal
TTI Transmission Time Interval
TX Transmitter
UARFCN UTMS Absolute Radio Frequency Channel Number
UCI Uplink Control Information
UE User Equipment
UL Uplink
UMTS Universal Mobile Telecommunication System
URLLC Ultra-Reliable Low-Latency Communication
USIM Universal Subscriber Identity Module
UTC Coordinated Universal Time
UTDOA Uplink Time Difference of Arrival
UTRA Universal Terrestrial Radio Access
UTRAN Universal Terrestrial Radio Access Network
WCDMA Wide CDMA
WI Work Item
WLAN Wide Local Area Network

1. A method by a first user equipment, UE, for signal reception in a cell using cell discontinuous transmission reception, DTRX, the method comprising:
receiving, from a network node, a cell DTRX configuration comprising at least an onDuration parameter and an inactivity timer, IAT, duration parameter;
receiving a downlink signal monitoring configuration;
monitoring a downlink channel according to the downlink signal monitoring configuration;
while monitoring the downlink channel according to the downlink signal monitoring configuration and during an onDuration period, detecting an IAT triggering event;
based on the IAT triggering event being detected, extending a downlink monitoring window based on the IAT duration parameter; and
monitoring the downlink channel during the extended downlink monitoring window.

2. The method of claim 1, wherein the onDuration parameter is the downlink monitoring window.

3. The method of claim 1, wherein the cell DTRX configuration further comprises a cell DTX onDuration.

4. The method of claim 1, wherein the IAT duration parameter comprises an amount of time for extending the downlink monitoring window.

5. The method of claim 4, wherein the amount of time for extending the downlink monitoring window initiates at a time instant associated with the detection of the IAT triggering event.

6. The method of claim 1, wherein the downlink signal monitoring configuration comprises at least one of connected mode DRX, cDRX, or search space.

7. The method of claim 1, further comprising terminating monitoring of the downlink channel at an end of the extended downlink monitoring window.

8. The method of claim 1, further comprising:
receiving, from the network node, an indication that no further downlink communication is expected; and
based on the indication, terminating the monitoring of the downlink channel prior to an end of the extended monitoring window.

9. The method of claim 1, wherein the cell DTRX configuration further comprises information indicating whether the IAT should be triggered or information indicating at least one activity in the downlink channel associated with the IAT triggering event.

10. The method of claim 1, wherein the IAT triggering event comprises at least one of:
a physical downlink control channel, PDCCH, and/or downlink control information, DCI, transmission to the first UE in the cell;
a PDCCH or DCI transmission to a second UE in the cell;
a PDCCH or DCI transmission comprising scheduling new data;
non-scheduling DCI;
a downlink reference signal;
a dedicated transmission indicating an IAT triggering event that triggers a preconfigured IAT duration;
a broadcast transmission indicating an IAT triggering event that triggers a preconfigured IAT duration;
a dedicated transmission indicating an IAT duration value; and
a broadcast transmission indicating an IAT duration value.

11. The method of claim 1, further comprising receiving a configuration indicating a field within at least one DCI format, and wherein the IAT triggering event is detected based on a value in the field in a received DCI.

12. A first wireless device, configured for signal reception in a cell using cell discontinuous transmission reception, DTRX, the first wireless device comprising processing circuitry configured to:
receive, from a network node, a cell DTRX configuration comprising at least an onDuration parameter and an inactivity timer, IAT, duration parameter;
receive a downlink signal monitoring configuration;
monitor a downlink channel according to the downlink signal monitoring configuration;
while monitoring the downlink channel according to the downlink signal monitoring configuration and during an onDuration period, detect an IAT triggering event;
based on the IAT triggering event being detected, extend a downlink monitoring window based on the IAT duration parameter; and
monitor the downlink channel during the extended downlink monitoring window.

13.-27. (canceled)

28. A method by a network node for configuring a user equipment for signal transmission or reception in a cell using cell discontinuous transmission reception, DTRX, the method comprising:
transmitting to a first user equipment, UE, a cell DTRX configuration comprising at least an onDuration parameter and an inactivity timer, IAT, duration parameter;
transmitting to the first UE, a downlink signal monitoring configuration;
configuring the first UE to:
while monitoring a downlink channel according to the downlink signal monitoring configuration and during an onDuration period, detect an IAT triggering event; and
based on the IAT triggering event being detected, extend a downlink monitoring window based on the IAT duration parameter; and
wherein the method further comprises transmitting on the downlink channel during the extended downlink monitoring window.

29. The method of claim 28, wherein the onDuration parameter is the downlink monitoring window.

30. The method of claim 28, wherein the cell DTRX configuration further comprises a cell DTX onDuration.

31. The method of claim 28 wherein the IAT duration parameter comprises an amount of time for extending the downlink monitoring window.

32. The method of claim 28, wherein the cell DTRX configuration further comprises information indicating whether the IAT should be triggered or information indicating at least one activity in the downlink channel associated with the IAT triggering event.

33. The method of claim 28, wherein the IAT triggering event comprises at least one of:
a physical downlink control channel, PDCCH, or downlink control information, DCI, transmission to the first UE in the cell;
a PDCCH or DCI transmission to a second UE in the cell;
a PDCCH or DCI transmission comprising scheduling new data;
non-scheduling DCI;
a downlink reference signal;
a dedicated transmission indicating an IAT triggering event that triggers a preconfigured IAT duration;
a broadcast transmission indicating an IAT triggering event that triggers a preconfigured IAT duration;
a dedicated transmission indicating an IAT duration value; and
a broadcast transmission indicating an IAT duration value.

34. The method of claim 28, further comprising transmitting, to the first UE, a configuration indicating a field within at least one DCI format, and wherein the IAT triggering event is detected based on a value in the field in a received DCI.

35. (canceled)

36. A network node for configuring a user equipment for signal transmission or reception in a cell using cell discontinuous transmission reception, DTRX, the network node comprising a processing circuitry configured to:
transmit, to a first user equipment, UE, a cell DTRX configuration comprising at least an onDuration parameter and an inactivity timer, IAT, duration parameter;
transmit, to the first UE, a downlink signal monitoring configuration;
configure the first UE to:
while monitoring a downlink channel according to the downlink signal monitoring configuration and during an onDuration period, detect an IAT triggering event; and
based on the IAT triggering event being detected, extend a downlink monitoring window based on the IAT duration parameter; and
wherein the processing circuitry is further configured to transmit on the downlink channel during the extended downlink monitoring window.

37.-48. (canceled)
